(19) United States
(12) Patent Application Publication
(10) Pub. No.: US 2020/0334628 A1
(43) Pub. Date: Oct. 22, 2020

(54) FOOD FULFILLMENT WITH USER SELECTION OF INSTANCES OF FOOD ITEMS AND RELATED SYSTEMS, ARTICLES AND METHODS

(71) Applicant: Zume Inc., Mountain View, CA (US)

(72) Inventors: Joshua Gouled GOLDBERG, San Bruno, CA (US); Christopher J. Satchell, Mountain View, CA (US)

(73) Assignee: Zume Inc., Mountain View, CA (US)

(21) Appl. No.: 16/849,402

(22) Filed: Apr. 15, 2020

Related U.S. Application Data
(60) Provisional application No. 62/836,532, filed on Apr. 19, 2019.

(51) Int. Cl. G06Q 10/08; G06Q 30/06; G06Q 50/04; G06Q 50/12; G05B 19/4155; G06K 9/62; B25J 11/00

(52) U.S. Cl. CPC G06Q 10/0832; G06Q 10/087; G06Q 30/0643; G06Q 30/0627; G06Q 30/0633; G06Q 30/0631; G05B 2219/50391; G06Q 50/04; G06Q 50/12; G05B 19/4155; G06K 9/6267; B25J 11/0045; G06Q 30/0639

(57) ABSTRACT

A fulfillment system presents attribute information (e.g., images, physical attributes) for food items in an inventory, allowing consumers to select individual instances of food items physical attributes, determined classifications, and predicted times of change of classification, for delivery or pickup. The fulfillment system may automatically capture images of the instance of a food item, and sense or determine physical characteristics, for example weight, size or spatial dimensions, density, color, non-visible wavelengths luster, amount of marbling, color, texture, scent (e.g., chemical compounds experiences as scent), tactile, sound and/or resistance to pressure or force, etc. The fulfillment system may identify a set of instances of food items of a selected type that possess specified physical characteristics, and present the set to the consumer for selection. Automated equipment can retrieve selected instances of food items and assemble selected instances into orders, for instance grocery orders, meal kits or assembled food items.

### CROSS-REFERENCE TO RELATED APPLICATIONS

The present application claims priority to U.S. Provisional Patent Application No. 62/836,532 filed on Apr. 19, 2019. The Provisional Patent Application, including any appendices or attachments thereof, is incorporated by reference herein in its entirety.

### TECHNICAL FIELD

This description generally relates to delivery or fulfillment of orders for food items, whether as orders for groceries, meal kits, or prepared meals or dishes.

### BRIEF SUMMARY

Many retailers such as e-commerce retails, restaurants or supermarkets entering the e-commerce environment are providing on-line (e.g., Worldwide Web-based) tools for ordering groceries and/or prepared foods for either pickup at a retail location or for delivery to a consumer at a home, office or other location. Further, some ride-hailing services are offering the ability for consumers to order prepared meals or even beverages on-line for delivery.

In a food delivery or pickup service, users have no problem selecting packaged goods, as they are somewhat fungible. However, with some food items, consumers may have very specific preferences on selection. Many consumers, whether home cooks, chefs at restaurants, etc., care significantly about the food items they consume, and in particular the specific instance of ingredients or “raw” food items that they will use to prepare a meal or beverage. The lack of physical interaction (visual, smell, and/or tactically) or confirmation by a user of these attributes of food is lost in conventional on-line sales environments and many users do not want to leave that decision up to others, whether they be man or machine or random—leading to what some call ‘the produce problem’.

In one aspect, a system and method may be summarized as determining a physical characteristic of an instance of food. The determining may include sensing a physical characteristics and/or determining a physical characteristic based on various attribute information. For example, determining a physical characteristic capturing images (visual, multispectral, or hyperspectral) at an intake point or point of processing, any point in the supply chain and packaging, of items of food. The captured image can capture a state of the specific instance of an item of food, which may be at the location (e.g., commissary) or other appropriate point in the supply chain, and may serve other purposes such as for quality control. Advantageously, the captured images can be presented to potential consumers, along with other attribute information such as physical characteristics of the instance of food item (e.g., weight, color information, spatial dimensions, density, or other objective measurements (e.g., moisture content, cooked tenderness of meat) to allow the consumer precise choice over which specific instances of food items the customer would like to order, for example for delivery or pickup. The physical characteristics may be used to determine a classification of the instance of food item, for example ripeness, (e.g., green vs. brown bananas, fat distribution (e.g., marbling) of a red meat product, preparation state—rare/medium/medium-well/well done, etc.). The determined classification may be dependent on time (e.g., ripeness) and the system may also predict when the instance of food may change the state of its classification (e.g., unripe to ripe).

The specific instances of food items could be delivered to the consumer in a raw state or a prepared state. For example, if a consumer wants a bunch of apples, the consumer could select which six apples the consumer would like to purchase out of a plurality of specific apples available in inventory. Also for example, if the consumer wants a steak, the consumer can choose by image and weight and amount of marbling the precise instance of steak they want to order. Optionally, the consumer could be provided with the option to choose to have the steak prepared to a desired level (e.g., rare, medium, well done) and/or prepared (e.g., cooked) in a specific manner (e.g., grilled, seared, broiled). In some implementations, the steak may be prepared while the steak is transported by a delivery vehicle enroute to a delivery or pickup destination.

If there is a large number of instances of a given type of food item available in inventory, the total number of instances of a type of food item made available to the potential consumer for selection could be reduced from what is available in the inventory. For example, the specific instances of a food item may be filtered based on any one or combination of physical characteristics, classifications, predicted time of classification transition, and/or other product information desired by the user. For example, a potential consumer may indicate a preference for more or less ripened fruit as compared to a displayed instance of food item, a stock or representative image of a particular one or more food attributes, and/or list of food attributes, and the choice presented to the potential consumer can be reduced or filtered based on correlated criteria from an inspection of the instances of food items. Additionally or alternatively, if there are 100 apples available, the potential consumer may be presented with a choice of 20 apples, which may within a user selected range of attributes (physical characteristics, classification, predicted change in classification, and/or other information). This reduction in choice could be implemented to satisfy the needs of the business, inventory location, promote some products near classification transition, and/or to reduce choice paralysis on the part of the potential consumer. Where a set of fulfillment facilities (e.g., delivery vehicles, pickup locations, kiosks or lockers) are employed, the choices of a second type of food item products made available for selection to a potential consumer may be reduced based on location of the fulfillment facility of a previous specific instances of food items of a first type of food item selected by the potential consumer for the particular order. For example, where a potential consumer selects a ribeye steak that weighs 2.85 lbs, the system may automatically reduce the choices presented to that potential consumer to reflect the specific instances of other types of food items (e.g., vegetables or consumer packaged goods) to those that are available in the respective inventories of delivery vehicles that have 2.85 lb ribeye steaks available. Additionally or alternatively, the system may automatically adjust prices based on availability in an inventory of instances of food items with particular attributes.

Yet a further advantage is that the application of sensing and determining (e.g., imaging, weighing, measuring dimensions, and/or other physical characteristics of individual instances of food items) can automate the process of provisioning an on-line shopping platform.

A method may be summarized as comprising: providing a user interface with a presentation of food items; receiving the at least one input, the at least one input including a first input that specifies a type of food item; in response to the at least one input, identifying, from at least one data store, a set of instances of food items based at least in part on the at least one input, the set comprising a plurality of instances of food items of the type of food item specified by the at least one input and that are each respective vendable items of food from at least one inventory of instances of food items; for each of the instances of food items in the set of instances of food items, retrieving, from at least one data store, attribute information of the instances of food items in the set of instances of food items, the attribute information including, for each of the instances of food items an image of the respective instance of the food item, the attribute information stored by the at least one data store prior to the identifying of the set of instances of the food items; causing a presentation of at least a portion of the retrieved attribute information of the instances of food items in the set of instances of food items, the information presented including, for each of the instances of food items the image of the respective instance of the food item; receiving an indication of a selection of at least one of the instances of the food items; and causing the at least one of the instances of the food items identified by the selection to be retrieved to fulfill an order.

Causing the presentation of attribute information includes causing the presentation of a weight or a spatial dimension of the respective instances of the food items.

Determining, based at least in part on a physical characteristic of a first instance of food item, a classification of the first instance of food item in the set of instances of food items, the classification comprising a representation of ripeness of the first instance of food item, wherein causing the presentation of attribute information includes causing the presentation of the classification of ripeness of the first instance of food item.

Determining, based at least in part on a physical characteristic of a second instance of food item, a classification of the second instance of food item in the set of instances of food items, the classification comprising a representation of marbling of the second instance of food item, wherein causing the presentation of attribute information includes causing the presentation of the classification of marbling of the second instance of the food item.

Causing the presentation of information about the instances of food items in the set includes causing the presentation of information that represents a respective firmness, luster, or density of a plurality of the instances of food items in the set

Causing the presentation of information may include causing the presentation of information that represents a respective aesthetic aspect of the respective instances of the food items. Causing the presentation of information may include causing the presentation of information in textual or alphanumeric form.

Receiving the at least one input includes receiving a second input that specifies at least one desired attribute of the type of food item, and wherein identifying a set of instances of food items includes identifying instances of food items having the at least one desired attribute specified by the second input.

Determining whether a total number of instances of food items satisfying a set of search criteria based on the first and second inputs exceeds a threshold, and wherein identifying the set of instances of food items includes selecting a subset of the total number of instances of food items to present via the user interface. Identifying instances of food items having the at least one desired physical characteristic, attribute or classifications specified by the second input may include applying one or more filters to the set of instances of food items previously identified by type of food item. The filtering may be performed before causing the presentation of information about the instances of food items in the set. Determining a subset of instances of food items to present via the user interface based at least on part on a current instances of food items available at a single inventory

Determining a subset of instances of food items to present via the user interface based at least on part on at least one or more previous selections.

Based on a first number of selected instances of food items, determining a set of inventory locations that have an inventory from which the selected instances of food items can be fulfilled. Reducing the set of instances of food items for presentation based on the current inventory available at one or more of the set of inventory locations

Causing the at least one of the instances of the food items identified by the selection to be retrieved to fulfill an order includes automatically causing a mechanism to retrieve the at least one of the instances of the food items identified by the selection.

For at least one of the instances of food items in the set of instances of food items, at least temporarily preventing any further identifying of the at least one instance of food item for a second user in response to a subsequent first input, until a termination criteria is reached.

Automatically assembling two or more of the instances of the food items identified by the selection to an assembled food item or meal kit.

Receiving at least one food preparation direction; and automatically preparing at least one of the instances of the food items identified by the direction.

The method may further comprise: automatically assembling two or more of the instances of the food items identified by the selection to an assembled food item. The method may further comprise: automatically assembling two or more of the instances of the food items identified by the selection to a meal kit. The method may further comprise: receiving at least one cooking direction; and automatically cooking at least one of the instances of the food items identified by the selection.

An article of manufacture may be summarized as comprising: at least one nontransitory processor-readable medium that stores processor-executable instructions which, when executed by at least one processor, cause the at least one processor to execute any of the methods described herein.

A processor-based system may be summarized as comprising: at least one processor; and at least one nontransitory processor-readable medium communicatively couple to the at least one processor and that stores processor-executable instructions which, when executed by the at least one processor, cause the at least one processor to execute any of the methods described herein.

An article of manufacture may be summarized as comprising: one or more nontransitory processor-readable media that stores processor-executable instructions which, when executed by at least one processor, cause the at least one processor to: provide a user interface with a presentation of fresh foods; in response to at least one input, identify a set of instances of food items; cause a presentation of information about the instances of food items in the set, the information including, for each of the instances of food items a captured still or moving image of the respective instance of the food item; receive an indication of a selection of at least one of the instances of the food items; cause the at least one of the instances of the food items identified by the selection to be retrieved to fulfill an order.

A system may be summarized as comprising: at least one processor; and at least one nontransitory processor-readable media communicatively coupled to the at least one processor and that stores processor-executable instructions which, when executed by the at least one processor, cause the at least one processor to: provide a user interface with a presentation of fresh foods; in response to at least one input, identify a set of instances of food items; cause a presentation of information about the instances of food items in the set, the information including, for each of the instances of food items a captured still or moving image of the respective instance of the food item; receive an indication of a selection of at least one of the instances of the food items; cause the at least one of the instances of the food items identified by the selection to be retrieved to fulfill an order.

The system may further comprise: at least one robotic appendage, and the processor-executable instructions, when executed, may cause the at least one processor to: automatically cause a robotic appendage to retrieve the at least one of the instances of the food items identified by the selection.

The system may further comprise: at least one appliance, and the processor-executable instructions, when executed, may cause the at least one processor to further: receive at least one preparation direction; and automatically prepare at least one of the instances of the food items identified by the selection.

The system may further comprise: at least one cooking appliance, and the processor-executable instructions, when executed, may cause the at least one processor to further: receive at least one cooking direction; and automatically cook at least one of the instances of the food items identified by the selection.

A method may be summarized as: for each of a plurality of instances of the food items of a single type of food item, capturing via at least one image sensor at least one image of the instance of the food item; sensing via at least one sensor at least one physical characteristic of the instance of food item that characterizes the instance of the food item; based on the image and the at least one physical characteristic of the instance of the food item, determining a classification of the instance of food item, and storing to at least one data store on one or more processor-readable media in a form retrievable for presentation, the captured image and at least one value the represents the at least one physical characteristic and the determined classification along with at least one identifier that uniquely identifies the instance of the food item at least until the instance of the food item is delivered to a user.

Sensing at least one physical characteristic of the instance of the food item includes capturing at least one of a weight, physical spatial dimension, firmness, sound in response to the instance of food being tapped, or smell of the instance of the food item.

Determining a classification includes determining a ripeness of the instance of the food item via at least one processor and storing an indication of the determined level of ripeness of the instance of the food item in the data store associated with the identifier.

Determining a ripeness of the instance of the food item includes assessing one or more colors, luster, firmness, sound, density or scent based at least in part on the at least one image and sensed physical characteristic of the instance of the food item. Determining a ripeness of the instance of the food item includes any two or more of: i) assessing one or more colors from at least one image of the instance of the food item; ii) assessing a luster of the instance of the food item; iii) assessing a firmness of the instance of the food item, the firmness measured via one or more tactile or pressure sensors; iv) assessing a scent from the instance of the food item detected by one or more chemical sensors; v) assessing a captured sound made by the instance of the food item in response to the instance of the food item being tapped; or vi) assessing a density of the instance of the food item.

Determining a classification includes determining an amount of marbling of the instance of the food item and storing an indication of the determined level of marbling of the instance of the food item in the data store associated with the identifier.

Determining a classification includes determining a first classification of the instance of food items from a set of classifications for the type of instance of food item, and further comprising determining a time when the instance of food item will change from the first classification to a second and different classification.

Determining at least one second physical characteristic based at least in part on the sensed at least one physical characteristic.

Preparing the instance of food item, capturing via a second image sensor a second image of the instance of the food item during preparation of the instance of food item. Preparing the instance of food item with an appliance, sensing via at a second sensor a second physical characteristic of the instance of food item that characterizes the instance of the food item as it is being prepared. Controlling at least one operational parameter of the appliance based at least I part on the second physical characteristic of the instance of food item. Controlling an appliance for preparation of the instance of food item based at least in part on the sensed at least one physical characteristic.

Receiving other product data of the instance of food item from a supply chain of the instance of food item, and wherein determining a classification of the instance of food item is based at least in part on at least a portion of the other product data.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements and have been solely selected for ease of recognition in the drawings.

FIG. 1 is a schematic diagram of an environment in which a fulfillment system allows customers to inspect and order instances of items of food via user controlled processor-based devices, according to at least one illustrated implementation.

FIG. 2 is a schematic diagram of an inventory management subsystem that automatically captures information about an instance of a number of food items, optionally analyzes the captured information, and stores the captured information in a data store to allow consumers to inspect and select individual instances of food items based on attributes of an instance of food, according to at least one illustrated implementation.

FIG. 3 is a schematic diagram of an environment controlled farm with an optional portion of an inventory subsystem that captures information about an instance of a number of food items, according to at least one illustrated implementation.

FIG. 4 is a schematic diagram of a production subsystem of the fulfillment system of FIG. 1, in which the production subsystem may produce packaged orders for delivery or pickup, according to at least one illustrated implementation.

FIG. 5 is a schematic diagram of a production subsystem and distribution subsystem of the fulfillment system of FIG. 1, the production subsystem at a fixed location and operable to assemble selected instances of food items as orders for distribution by the distribution subsystem, according to at least one illustrated implementation.

FIG. 6 is a schematic diagram of a production subsystem and distribution subsystem of the fulfillment system of FIG. 1, the production subsystem on-board a vehicle and operable to assemble selected instances of food items as orders, for distribution by a separate or integrated distribution subsystem, according to at least one illustrated implementation.

FIG. 7 is a block diagram of a processor-based system, according to one or more illustrated embodiments.

FIG. 8 is a logic flow diagram of a method of operating a fulfillment system or portion thereof to inventory instances of food items, according to at least one illustrated implementation.

FIGS. 9-1 and 9-2 are logic flow diagrams of a method of operating a fulfillment system or portion thereof to inventory specific instances of food items, according to at least one illustrated implementation.

FIG. 10 is a logic flow diagram of a method of operating a fulfillment system or portion thereof to determine ripeness of specific instances of food items, according to at least one illustrated implementation.

FIG. 11 is a logic flow diagram of a method of operating a fulfillment system or portion thereof to cause implementation of a user interface to present information about, and selection of, instances of food items, according to at least one illustrated implementation.

FIG. 12 is a logic flow diagram of a method of operating a fulfillment system or portion thereof to cause implementation of a user interface to present information about, and selection of, instances of food items, according to at least one illustrated implementation.

FIG. 13 is a logic flow diagram of a method of operating a fulfillment system or portion thereof to cause implementation of a user interface to present information about, and selection of, instances of food items, according to at least one illustrated implementation.

FIG. 14 is a logic flow diagram of a method of operating a fulfillment system or portion thereof to cause implementation of a user interface to present information about, and selection of, instances of food items, according to at least one illustrated implementation.

FIG. 15 is a logic flow diagram of a method of operating a fulfillment system or portion thereof to cause implementation of a user interface to present information about, and selection of, instances of food items, according to at least one illustrated implementation.

FIG. 16 is a logic flow diagram of a method of operating a fulfillment system or portion thereof to receive selections of instances of food items and prepare the selected instances of food items, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with food preparation devices such as ovens, skillets, and other similar devices, closed-loop controllers used to control cooking conditions, food preparation techniques, wired and wireless communications protocols, geolocation, and optimized route mapping algorithms have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

As used herein the term “food” refers to any product intended for human consumption. As used herein, the term “food item” or ‘vendable item of food’ refers to any food and may include without limitation, a raw item of food (e.g., vegetables, fruits, meat, fish), a cooked item of food (e.g., a cooked carrot, a cooked steak, cheese, bread), or an assemblage of food items (e.g., a container of one type or various types of vegetables with or without dip, soup (unheated or heated), an uncooked pizza, a cooked pizza, a meal kit with or without instructions and recipes). As used herein the term “instance of a food item” and variations thereof refer to an actual distinct vendable item of food which can be ordered by a user and which will be provided to the user, and which is not just a representation or example or stock image of a type, variety or cultivar of food items (e.g. Macintosh apple, sirloin steak, pepperoni pizza). Although illustrated and described herein in the context of generally non-fungible groceries, e.g., fresh food, to provide a readily comprehensible and easily understood description of one illustrative embodiment, one of ordinary skill will readily appreciate the broad applicability of the systems, methods, and apparatuses described herein across any number of unprepared and prepared food products, packaged foods, meal kits, etc.

As used herein the term “appliance” refers to any device, system, or combination of systems and devices useful in the preparation of a food item. While such preparation may include the heating or cooking of food products during preparation, such preparation may also include the partial or complete cooling or even freezing of one or more food items. Preparation may additionally, or alternatively include: rinsing, washing, peeling, cutting, slicing, dicing, pureeing, juicing, mixing, shake, folding, and/or blending of one or more food items. Appliances may, for example, include cooking appliances for heating or cooking food items and may include but not limited to: stoves, burners, griddle, grill, toasters, microwave ovens, conventional ovens, convection ovens, deep fryers, rice cookers, slow cookers, sous vide cookers, etc. Cooking appliances may be able to control more than temperature. For example, some cooking appliances may control pressure, air flow/convection and/or humidity. Appliances may include. one or more of cooling appliances (e.g., refrigerators, freezers), washers, scrubbers, peelers, cutters, food processors, juicers, mixers, and or blenders, mixers.

### Description of System Environments

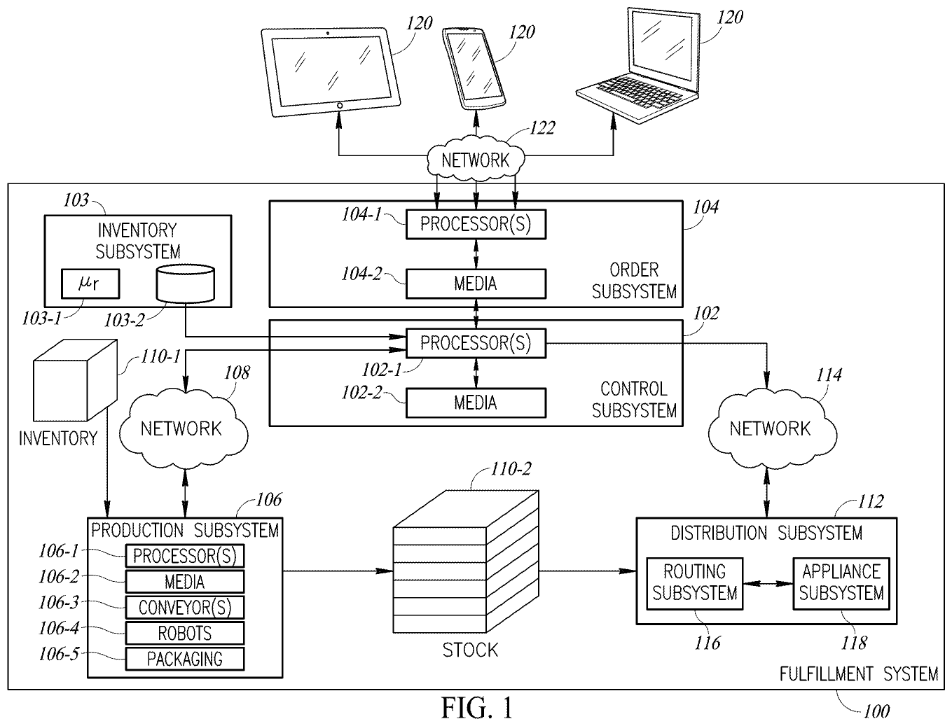

FIG. 1 shows an environment in which an order fulfillment system 100 operates to fulfill orders according to selections by users, according one illustrated implementation. The order fulfillment system 100 includes at least one control subsystem 102, an inventory management subsystem 103, an order subsystem 104 communicatively coupled to one or more user devices 120 via at least one communications channel (e.g., network 122), a production subsystem 106 communicatively coupled to the control subsystem 102 via at least one communications channel (e.g., network) 108, and a distribution subsystem 112 communicably coupled to the controller 102 via a one or more communications channels (e.g., network) 114.

In at least some implementations, the environment may include an inventory of materials 110-1 (e.g., various instances of packaging and food items) from which orders can be fulfilled, for instance parcels of groceries and sundries, prepared food items and/or meal kits. The orders may be individually packaged, and optionally collated or grouped for loading as stock 110-2 onto delivery vehicles or for pickup, for instance loaded onto pallets or racks.

The inventory management subsystem 103 includes one or more processors 103-1 (e.g., microprocessors, graphic processing units (GPUs), digital signal processors (DSPs), application specific integrated circuits (ASICs), field programmable gate arrays (FPGAs) programmed logic controllers (PLCs), other logic circuits) and nontransitory processor-readable storage media 103-2 (e.g. volatile memory, non-volatile memory, spinning disks including magnetic hard drives, optical drives). The inventory management subsystem 103 obtains and/or maintains attribute information about or which characterizes specific instances of food items in one or more inventories 110 of food items. Attribute information includes physical characteristic information (whether sensed directly or determined), classification information, a predicted change in classification information, and other information about the instance of food item. The physical characteristic information may include any one or more measured or determined physical characteristics. The one or more physical characteristics may include without limitation weight, size or spatial dimensions, density, color or hue, non-visible wavelengths, scent (chemical compounds experiences as scent), pH, moisture content, firmness (resistance to pressure or force), tactile (surface roughness or smoothness), sound, density, luster, etc. of the instance of food. The determined classification of the instance of food may include any one or more or combinations of level of ripeness, amount of marbling, crispness, cooking level (e.g., rare, medium, well), yield grade, etc. The other product information (e.g., expiration date, use by date, sell by date, price, location of storage or transit, source name, rating (Grade A; Premium), category (large, small, lean, fat, organic, natural, conventional, sourced locally, free range, cruelty free, gluten free, peanut free, low sodium, sugar free, low sugar, Kosher, Halal), etc.) may be received by the inventory management subsystem from any appropriate entity, such as a source farm or other entity within the food supply chain. The other product information may be used along with the physical characteristic information by the inventory management subsystem to determine the classification and/or the predicted change of classification for an instance of food item. The inventory management subsystem may store the attribute information (physical characteristic, determined classification, predicted change in classification, and other information) of the food item in the nontransitory processor readable storage media 103-2 associated with an identifier for the instance of food item.

As described in more detail herein, the inventory management subsystem 103 may include various types of sensors (not shown) which may include invasive and/or non-invasive (e.g., image sensors or cameras, load cells, chemical compound detection sensors, microphones, pressure sensors, ultrasonic sensors, weight sensor, humidity sensors, etc.) and other equipment to sense information about the physical characteristics of an instance of a food item in the inventory 110, or alternatively may be communicatively coupled to receive information from various types of sensors.

The inventory management subsystem 103 may determine a classification of an instance of food item based at least in part on one or more of the physical characteristics of the instance of food. For example, based on the color, softness, smell physical characteristics, the inventory management system may classify the instance of banana food item as unripe, ripe or over ripe, or any other appropriate classification. Similarly, based on the firmness, and color distribution, the inventory management system may determine a classification of a steak food item as lightly marbled or highly marbled, or fatty and lightly marbled, and if cooked the inventory management system may additionally or alternatively classify the steak food item as rare, medium or well done. The inventory management subsystem may store the determined one or more classifications in the storage media 103-2 associated with an identifier for the instance of food item.

The inventory management system 103 may determine a change in classification of an instance of food item based at least in part on one or more of the attributes of the instance of food. For example, as noted above, the inventory management subsystem may determine the classification of ripeness of a food item and based on that same and/or other product information, may predict, if and when that classification may change status (e.g., time when change from unripe to ripe, and/or time when change from ripe to over ripe). The prediction of time of change of classification may be based on many methodologies and techniques such as machine learning, AI, data analysis, etc.

The order subsystem 104 includes one or more processors 104-1 and nontransitory processor-readable storage media 104-2. The order subsystem 104 causes a presentation of a set of instances of food items to a user for selection, which may be at the user device 120, and additionally may present all or a portion of attribute information associated with that instance of food item which may include in any portion or combination of measured physical characteristic information, determined physical characteristic information, the classification information, and/or predicted information, and any other information (e.g., price, expiration date, location, etc.) of the instance of an item of food. As explained herein, the order subsystem 140 may cause a presentation to the user, of still or moving images of the instance of food item that is available to be ordered, along with selected attribute information. Display of any portion and/or combination attribute information may allow a user or consumer to select instances of items of food based on the user's own preferences.

A user may visually inspect the instance of food item, for instance via images displayed via the user device 120, and also review the presented attributes. The user may indicate, enter or select desired (or undesired) physical characteristics, classifications, predictions, and other product information for filtering, such as through a user interface of the user device 120. The order subsystem may then compare the received user indications with the attributes of the instance of food item and determine and present to the user a filtered set of instances of food items meeting the attribute criteria indicated by the user. The filtering may be performed before causing the initial presentation of information about the instances of food items in the set to the user, and in some cases may be modified and/or repeated multiple times based on user indications and/or other user data and interactions. For example, additionally or alternatively, a set of attributes may be determined by the order subsystem based on user selections through the user's interaction with the information, previous selections by the user, by a group of similar users, or based on combinations of food items that are typically purchased together, and a filtered set of instances of food items with specified attribute information may be identified and presented.

The order subsystem 104 can curate sets of instances of food items to present to the user. For example, the control subsystem may provide sets of instances of food items based on a type of food item and one or more desired attributes. The desired attributes of the food items may, for example, be specified by a user via the user interface. For example, the control subsystem 102 may include one or more machine learning or similar algorithms useful for predicting demand for instances of food items having certain attributes. For example, the order subsystem 104 may include one or more machine learning algorithms able to correlate or otherwise logically associate previous orders placed by a user or a plurality of users, with attributes that the user desires in instances of food items. For example, a given user may show a tendency to select a steak having the highest percentage of marbling, or lettuce having a certain hue, or an apple having a certain amount of luster. The order subsystem may store the attribute data in the storage media 104-2 associated with a food item indicator, and which may (or may not) be associated with a user identifier and/or anonymized user information (geographic, temporal period, event, etc. information) to correlate, aggregate or associate with other users. Also for example the order subsystem 104 may include one or more machine learning algorithms able to correlate or otherwise logically associate previous orders placed by a user a constrained geographic area (e.g., a college campus) in which the user is presently located, a defined temporal period (e.g., Friday evenings at 6:00 PM) or during one or more defined events (e.g., cookout, a football or basketball game). In such instances, the order subsystem 104 may autonomously identify sets of instances of food items having attributes which are determined as likely to meet the desires of the user based at least in part on anonymized user information of previous users. More complex approaches to defining sets of instances of food items are described elsewhere herein.

The order subsystem 104 may cause the attribute information to be presented via a user interface (e.g., presented on a display, speakers, haptic engine) rendered at a user operated processor-based device 120. The order subsystem 104 may receive selections for individual instances of food items, constituting food orders, placed by a user using any number or variety of sources. In some instances, the order subsystem 104 may include a network interface, for example a network interface communicably coupled to the Internet 122, over which orders may be placed via a table computer, smartphone, or via any type of processor-based computing device 120. In such instances, selections corresponding to a desired food items and other order information, e.g., destination address, delivery time, and the like, may be received by the order subsystem from the user in a format requiring minimal or no reformatting by the order subsystem 104 prior to providing the data representative of the order to the control subsystem 102 and/or storage in the storage media 104-2.

The production subsystem 106 includes one or more processors 106-1 and nontransitory processor-readable storage media 106-2. The production subsystem 106 may also include one or more conveyors 106-3 (e.g., driven conveyor belts, passive roller conveyors), robots 106-4 (e.g., robotic vehicle or tugs, robotic appendages) and/or one or more packaging machines 106-5. The production subsystem 106 assembles selected instances of food items into an order. As explained herein, the order may be an order for one or more actual distinct vendable items of food. As explained herein, the production subsystem 106 may employ one or more mechanical devices or components, for instance one or more driven or passive conveyors 106-3, one or more robotic vehicles or robotic appendages 106-4, that are operable to assemble a collection of instances of food items into orders, and optionally one or more packaging machines 106-5 operable to package (e.g., box, bag, cling wrap) each order. The packaging machine 106-5 may package each instance of a vendable food item separately, and/or with other vendable food items of the same order. As explained herein, in some implementations the production subsystem 106 and/or distribution system 112 may include or appliances operable to prepare (e.g., assemble, rinse, wash, peel, cut, slice, dice, puree, juice, mix, shake, fold, blend, refrigerate, freeze, heat or cook, or otherwise process) one or more instances of food items.

The production subsystem may use one or more of the instances of food item attributes to determine which type and/or amount of preparation and/or packaging to utilize. For example, the classification of the instance of food item (e.g., ripeness related measurements or assessments) may be used to determine how to package a given instance of a food item. For example, the production subsystem (and in some cases the inventory subsystem) may indicate or cause a cellulose-based sealant to be applied to the instance of the food item as a natural preservative, or store instances of fruits with relatively higher levels of ethylene away from instances of fruits with relatively lower levels of ethylene, in order to preserve specific different levels of ripeness within the inventory.

The distribution subsystem 112 is operable to distribute orders to destinations. As explained herein, the distribution subsystem 112 may include one or more manually driven vehicles (i.e., manually driven by human driver), autonomous vehicles, semi-autonomous vehicles, kiosks, storage lockers, etc. The distribution subsystem 112 may include a routing subsystem 116. The routing subsystem 116 performs routing operations, for instance determining travel routes to destinations, and/or providing routing information to an autonomous or semi-autonomous vehicle.

The control subsystem 102 and/or order subsystem 104 can include one or more processor-based systems or devices used to coordinate the receipt or generation of orders. In at least some instances, the control subsystem 102 can provide the user placing an order with an estimated delivery time for the order or time at which the order will be available for pickup. The estimated delivery time may be generated by the routing subsystem 116 of the distribution subsystem 112. In at least some instances, the estimated delivery or pickup time may be based on an estimated time to assemble the selected instances of food items into an order by the production subsystem 106, and where the order includes one or more food items that are to be prepared by an appliance (e.g., cooked, reheated, cooled, chopped, etc.) an estimated time to prepare the food item by the distribution subsystem 112. It is noted that food preparation may occur during transit, and the estimated delivery time may account for any overlap between preparation and transit times. Such estimated delivery or pickup times may consider factors such as the complexity of assembly or collation of the food items, and if required preparation and the time needed for the desired or defined preparation process (such as grill, bake, fry, etc.) associated with ordered food items. Such estimated delivery times may also consider factors such as road repair, predicted or real-time traffic and weather conditions, time of day, and other factors affecting the delivery of the food item by the distribution module 112 and may provide turn by turn navigation or simple destination coordinates. The estimated travel or transit time to a delivery destination may be dynamically updated during transit. In other instances, the estimated delivery or pickup time may reflect the availability of the ordered food item on a delivery vehicle that has been pre-staged in a particular area or availability at a fixed location (e.g., commissary).

The control subsystem 102 or production subsystem 106 can schedule the retrieval from storage, assemble or production of food items in accordance with the received or generated orders. In some instances, the production subsystem 106 may be collocated with or even incorporated into the control subsystem 102. Responsive to receipt of one or more outputs provided by the control subsystem 102 or the order subsystem 104, food items are prepared by the production subsystem 106. In at least some instances, the production subsystem 106 may autonomously perform the preparation of the selected instances of food items. For example, one or more components of the production subsystem 106 may retrieve selected food items from an inventory 110-1, and assemble the retrieved food items as a collection of selected instances of food items constituting an order. In some implementations, one or more components of the production subsystem 106 may prepare individual or groups of the selected instances of food items, for example, rinsing, washing, cutting, slicing, dicing, pureeing, mixing, freezing, heating, and/or cooking. In some implementations, one or more components of the production subsystem 106 may load the selected instances of food items into one or more appliances. In some implementations, one or more components of the production subsystem 106 may load the appliances into a rack 110-2 to store and/or transfer the collection of selected instances of food items for the distribution system 112.

In some implementations, the distribution subsystem 112 may include an appliance subsystem 118. The appliance subsystem 118 may generate commands to operate or control one or more appliances. The appliance subsystem 118 may, in some implementations, consider an estimated travel time to a delivery destination, which may be dynamically updated during transit. The appliance subsystem may control the one or more appliance operational controls, such as temperature, time to turn on, time to turn off, humidity, or any other operational control parameter of any particular appliance of the distribution system 112.

In some implementations, the appliances may contain prepared or assembled, uncooked, food items, and can be placed in a rack of stock 110-2 which may be separate or a part of the production system or the distribution system 112. The rack can include various components or systems to support the operation of the appliances contained in the rack, for example a power distribution bus, a communications bus, and the like. Sets of power and/or control condition instructions can be supplied to the appliances either individually or via the power distribution and communications buses in the rack.

In some implementations, operations conditions within each of the appliances are controlled enroute to a destination (e.g., location consumer specifies for delivery or pickup) such that preparation of the food items in the appliance is completed shortly prior to or upon arrival at the specified destination. In at least some instances the control subsystem 102 can communicate via network 114 with the distribution subsystem 112 to control some or all operation conditions and functions in one or more of the appliances. In at least some instances, the location of each appliance or rack in the distribution subsystem 112 may be monitored using geolocation information. Such geolocation information may be determined using time-of-flight triangulation performed by the control subsystem 102 and/or routing subsystem 116. Such geolocation information may be determined using one or more global positioning technologies, for example the Global Positioning System (GPS) or similar. The control subsystem 102, the routing subsystem 116, and/or the appliance subsystem 118 may use the location information and/or estimated preparation time to statically or dynamically create and/or update delivery itinerary information and estimated time of arrival information for each consumer destination and may provide an optimal delivery itinerary, estimated delivery time, and available preparation times for a plurality of appliances and/or orders.

In some instances, an appliance subsystem 118 that is part of, or communicably coupled to, the distribution subsystem 112 can provide some or all of the adjustments to operational conditions within the appliances such that the food items in each of the respective appliances are fully prepared (cooked, cooled, chopped, etc.) shortly before arrival at the consumer specified destination. In at least some instances, the appliance module 118 may use data provided by the routing subsystem 116 to determine operational control parameter conditions within some or all of the appliances. In yet other instances, standalone loop controllers may be located within each appliance to control some or all functions including power delivery and/or operational conditions in the respective appliance. Various structures and methods from U.S. Pat. No. 9,292,889, U.S. patent application Ser. No. 62/532,885 and/or International patent application PCT/US2018/040714 may be employed.

In at least some instances, all or a portion of the determined geolocation information associated with food item(s) ordered by a user may be provided to the user device used use to facilitate the order or another user device, for example via a Website, computer program, or smartphone application.

Additionally or alternatively, one or more appliance sensors (not shown) may capture attribute information of the food items in the appliances at one or more times. For example, images may be captured when the food item is loaded, unloaded, and/or through the cooking process. A physical characteristic of the food item (e.g., scent, sound, humidity/moisture, external or internal temperature, etc.) may be detected or determined which can provide an indication of the level of completeness of the food preparation process, and may be used to determine a classification of the food item (e.g., rare, medium, well done) and may be used to determine a time to a change in the classification of the food item. The information may be employed to control the food preparation process or appliance, food preparation conditions, update the estimated time of delivery, and/or presented or made available to the user who ordered the instance of food item, or a potential user as a possible food item selection.

In at least some instances, all or a portion of the control subsystem 102 can be located remote from the production subsystem 106, for example in a corporate server, or in a network connected or “cloud” based server. The network 108 can include a local area network, a wide area network, a worldwide network, a private network, a corporate intranet, a worldwide public network such as the Internet, or any combination thereof.

Although in some instances illustrated as discrete components or subsystem, some or all of the operations or functionality performed by the control subsystem, inventory management subsystem, order subsystem, production subsystem, distribution subsystem, routing subsystem, and/or appliance subsystem may be shared between or combined and performed by another system component. For example, the control subsystem 102 may perform various order functions and/or attribute determination and predictions rather than a dedicated order subsystem 104. In some implementations, an order subsystem 104 may be disposed in a national or regional call or order aggregation center that is remote from the control subsystem 102. In another example, the routing subsystem 116, and/or the appliance subsystem 118 may be disposed in some or all of a plurality of delivery vehicles 701 (e.g., autonomous delivery trucks).

The fulfillment system 100 advantageously allows consumers to pick individual instances of food items, e.g., raw, un-processed or un-prepared food items or ingredients based on visual appearance and other attributes of the instance of food item, not just representative or examples of food items.

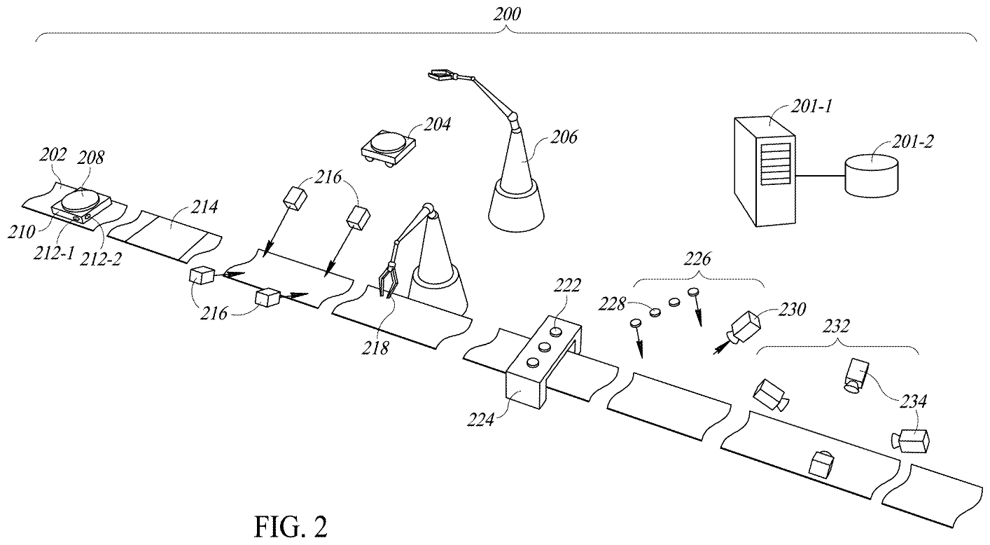

FIG. 2 shows an inventory management subsystem 200, according to at least one illustrated implementation. The inventory management subsystem 200 may implement the inventory management subsystem 103 of FIG. 1.

The inventory management subsystem 200 may be located in a variety of places, at or proximate a site at which the food items are grown or raised, for instance a conventional farm, or a controlled environment farm or other controlled growing or farming or raising facility. Also for example, the inventory management subsystem 200 may be positioned at or proximate a warehouse, fulfillment center, commissary or any other appropriate location.

As described in more detail herein, the inventory management subsystem 200 may capture information about a plurality of instances of food items, and store the captured information along with a logical association (e.g., identifier, pointer, field in a record) to the respective instance of a food item, for example via a processor based computer 201-1 and nontransitory processor-readable storage media 201-2.

The inventory management subsystem 200 may comprise one or more transport mechanisms, for example one or more conveyors 202, robotic vehicles 204 and/or robotic appendages 206, to transport instances of food items 208, for example to one or more stations. The instances of food items 208 may be transported via a container 210. Each container 210 may carry a respective single instance of a food item 208, or may have compartments that carry respective instances of food items 208. The instances of food items 208 and/or totes 210 may bear some machine-readable information, for example one or more machine-readable symbols 212-1 (e.g., one- or two-dimensional machine-readable symbols such as barcode symbols) or wireless transponders 212-2 (e.g., radio frequency identification (RFID) transponder), which provide a logical association to container, compartment and/or the instance of food item 208.

The inventory management subsystem 200 may include one or more sensing systems 214, 216, 218, 222, 226, 232, which may sense and/or determine one or more physical characteristics of the instance of food item. Any appropriate sensing system may be used, and non-limiting examples of which are described further below. While the below examples illustrate non-invasive sensing system technologies, it is to be appreciated that invasive sensing (measuring the internal parameter of the instance of food item) may be used alternatively or additionally, e.g., temperature probe, moisture sensor, Ph sensor, etc. The inventory management subsystem 200 saves the physical characteristic, or a representation thereof, to nontransitory processor-readable media 201-2 along with a logical association to the respective instance of food item 208. Based at least in part on the sensed physical characteristic, the inventory subsystem may determine a physical characteristic of the instance of food item (e.g., density, luster, etc.)

For example, the sensor may include a weight sensor 214, such as one or more load cells 214, operable to sense or measure a weight of the instance of food item 208. The load cells 214 or an associated processor may implement a tare function to subtract out the weight of a carrier (e.g., tote 210). Alternatively, the instance of food item 208 may be transferred to the load cell 214 from the carrier (e.g., tote 210) for weighing.

The inventory management subsystem 200 may include a dimensioning system 216, operable to sense or measure spatial dimensions (e.g., length, width, height, diameter, radius, periphery) of the instance of food item 208. The dimensioning system 216 may take the form of a contact or coordinate measuring machine that employs one or more probes that contact the item to be dimensioned. The dimensioning system 216 may take the form of non-contact dimensioning systems, for employing sensors (e.g., laser, optical sensor). The dimensioning system 216 may capture dimensions in three-dimensions.

The inventory management subsystem 200 may include one or more tactile sensors 218 to sense or measure rigidity or stiffness or elastic modulus of the instance of food item 208. The tactile sensors 218 may take the form of a probe that applies a force or pressure to the instance of the food item 208, sensing the amount of force or pressure applied to the instance of the food item 208 when deformation of the instance of the food item 208 begins to occur, or measuring an amount of deformation that results from application of a defined force or pressure.

The inventory management subsystem 200 may include one or more chemical compound sensors 222 to sense the presence or measure an amount of one or more chemical compounds (e.g., volatile organic compounds) emanating from the instance of food item 208. One or more hoods 224 or other housings may be employed to isolate each instance of food item 208 from other instances and from the ambient environment, and the chemical compound sensor(s) 222 positioned to sense the atmosphere within the hood 224. Such may also advantageously collect chemical compounds emitted by each instance of food item 208 over a period of time to facilitate sensing. The chemical compounds may be those associated with a level of ripeness for or more types of food items (e.g., apples, bananas), for instance ethylene. The chemical compounds may be those associated with a level of decay or spoilage for or more types of food items (e.g., milk, meat, fish), for instance acetone, methyl ethyl ketone, toluene, ethylbenzene, m, p-xylene, styrene, and o-xylene. The inventory management subsystem 200 saves an indication of whether one or more chemical compounds were sensed and/or measured or representation a level of the sensed chemical compounds. In some cases, the sensor 222 may include a probe and/or contact sensor which may alternatively or additionally measure an internal and/or external Ph or other chemical attribute of the instance of food item.

The inventory management subsystem 200 may include one or more spectral sensing systems 226 which may include one or more light sources 228 operable to emit light in one or more discrete bands of wavelengths, and one or more optical sensors 230 operable to detect light returned from the instance of food item 208. The optical sensors 230 may be responsive to respective bands of wavelengths. The spectral sensing system 226 may include one or more optical filters positioned to filter light emitted by the light sources 228 or returned to the optical sensors 230. The optical sensors 230 may sense or detect a presence of light in a given band of wavelengths or may measure an amount of light in a given band of wavelengths, and in some instance may emit a pattern of spectra and measure the reflect of the pattern. In some cases, the bands will be different from the band commonly referred to as visible light or visible wavelengths, for example the near-infrared band, or the ultraviolet band of the electromagnetic spectrum.

The inventory management subsystem 200 may include one or more vision or image capture systems 232 which may include one or more image sensors 234 (e.g., cameras) operable to capture still or moving images of the instance of food item 208, preferably in color. The image capture system 232 optionally include one or more light sources (not shown) with a respective color temperature set to result in the capture of images that accurately represent the actual color of the instance of food item 208. The inventory management subsystem 200 may implement specification of calibration parameters for the light sources, for instance allowing any image to be adjusted to match the color as seen by the human eye in sunlight, moonlight, or the specific light temperature of a user's preparation or dining area. The light sources may be capable of high levels of illumination to result in high resolution images.

One or more components of the inventory management subsystem 200 may be removably coupled to allow detachment for cleaning, maintenance, replacement, etc. Additionally or alternatively, the inventory management subsystem 200 may include one or more cleaning stations at which the various components may be cleaned and/or sanitized or even sterilized. Cleaning stations may include mechanical scrubbers, ultrasonic vibrators, ultraviolet lighting, nozzles, pressure systems (e.g., pumps, compressors) and reservoirs fluidly coupled to dispense cleaning fluids in liquid or gaseous forms, heaters and/or pressure vessels (e.g., autoclaves), etc. For example, any manipulator or end-effector on a robot have a respective cleaning station to comply with food safety regulations and prevent cross contamination between instances of food items.

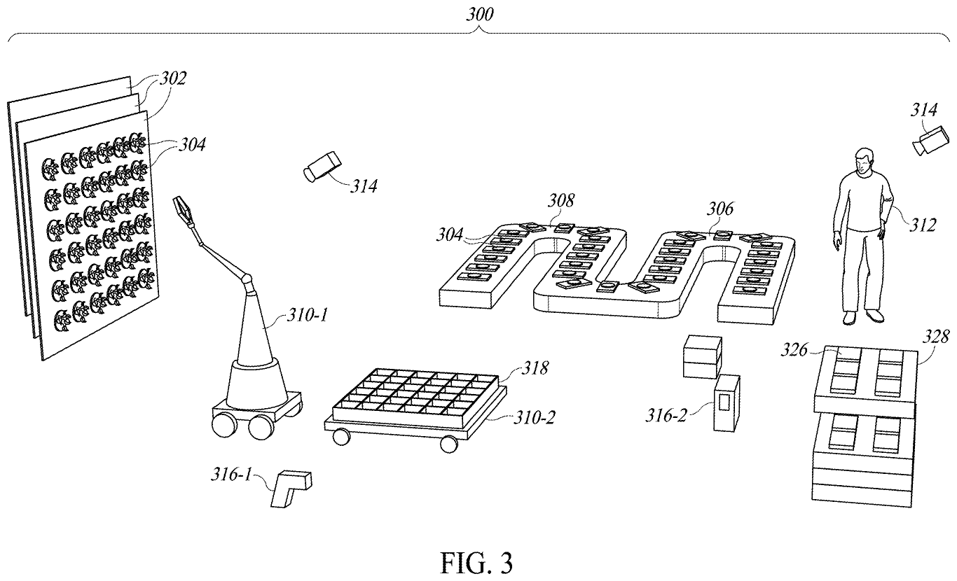

FIG. 3 shows a controlled environment farm 300, and can take any of a variety of forms, and may include one or more enclosed areas in which the environment (e.g., temperature, humidity) may be controlled. The farm 300 may rely on natural sunlight, artificial light or a combination thereof. The farm 300 may employ a soil and/or non-soil growth medium, which may be in a particulate or liquid form. The farm 300 may include one or regions in which food items are grown, farmed or raised. These regions can take any of a large variety of forms, and may depend on what is being grown, farmed, or raised. For example, one or more vertical structures (e.g., frames) or walls 302 may be employed to grow certain food items 304 (e.g., vegetables or fruits). Also for example, one or more pools 306 may be employed to grow certain vegetables or fruits, for example floating one or more containers 308. The pool(s) 306 may be arranged so that the containers 308 traverse a length thereof, reaching successive locations as certain food items 304 (e.g., lettuce) grow or mature. Lighting or nutrient concentrations may vary along the length of the pool(s) 306 in accordance with the needs of the plants at various stages of growth. In some implementations, the pool(s) 306 may form a continuous or endless loop.

One or more robots (e.g., robotic appendages 310-1, robotic vehicles 310-2, or combinations thereof) may be employed in planting, growing and/or harvesting. Additionally or alternatively, one or more people 312 may be employed in planting, growing and/or harvesting. The farm 300 may include one or more sensors systems to collect information about the instance of food items. Any appropriate type and number of sensing systems may be used to monitor and/or control the farm, including temperature sensors, moisture sensors, humidity sensors, light sensors, location/orientation sensors, machine readable symbols and/or RFID chips (not shown) may be associated with any one or more of the robotic appendages, robotic vehicles, container 318 or compartment of container 318 etc. Alternatively or additionally, an instance of a food item 304 may carry or bear a respective identifying machine-readable symbol or wireless transponder (e.g., plant tag, or printed identifier directly on plant or instance of food item). The sensing system may additionally or alternatively include one or more cameras 314, machine-readable symbol readers 316-1, and/or RFID interrogators 316-2. The collected information may be saved in a nontransitory storage media to provide a provenance for the instance of a food item, including location and/or date of origin, a list of nutrients, other growing conditions, proof of having been grown organically, etc. The collected information may include complete supply chain information, tracking the instances of food items from farm to consumer. Such may information may be secured via a block-chain storage across multiple processor-based systems. Additionally or alternatively, handling instructions, preparation instructions and/or further processing instructions may be based in part or in whole on the collected information. The collected information from the farm 300, or representations of or determinations from the collected farm information, may be provided to the inventory management system through an appropriate communication coupling for storage associated with a logical association of the instance of food item as other product information of the attribute information.

In some implementations, part or all of the inventory management subsystem 103, 200 may be located at or proximate the farm 300, for example to sense, measure or capture attributes as instances of food items are grown, harvested and/or processed.

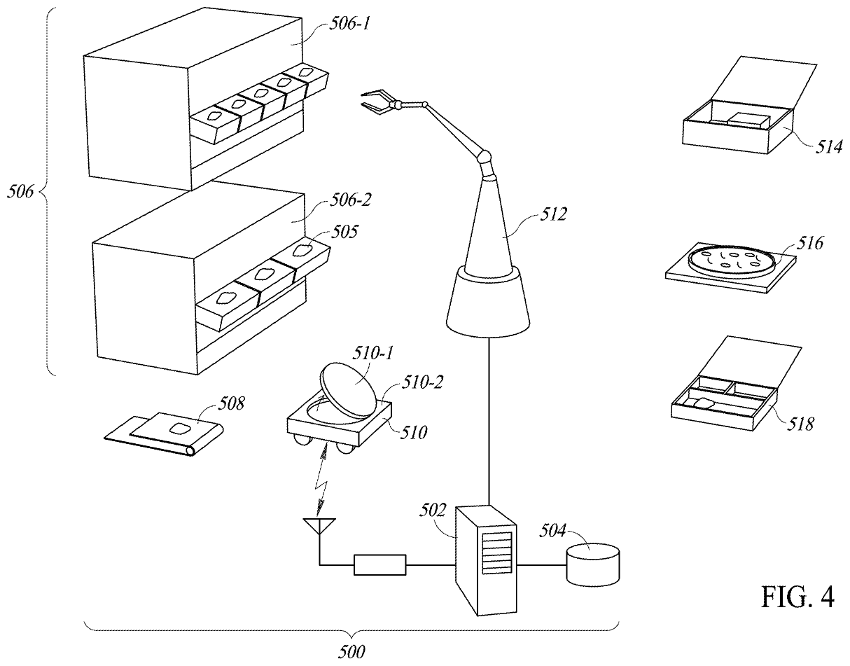

FIG. 4 shows a production subsystem 500, according to at least one illustrated implementation, and may implement the production subsystem 106 (FIG. 1).

The production subsystem 500 may include one or more computer systems 502 with one or more processors and one or more nontransitory processor-readable media 504 (which stores processor-executable instructions which, when executed by the at least one processor, cause the at least one processor to retrieve selected instances of food items 505 (only one called out) from an inventory 506, and assemble the retrieved instances of food items into orders.

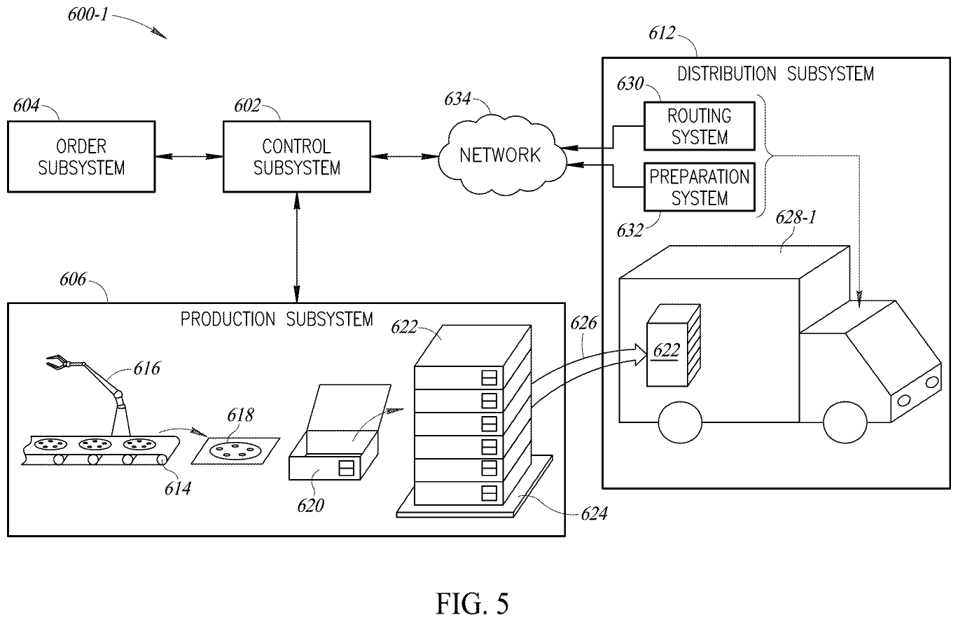

The production subsystem 500 may include one or more handling mechanisms, for example one or more conveyors 508, one or more robotic vehicles 510, and/or one or more robotic appendages 512. The conveyor(s) 508 may be driven or passive, and are operable to transport selected instances of food items 505 between various locations, for example from one or more locations in the inventory 506 to one or more assembly locations. The robotic vehicle(s) 510 may be autonomous, semi-autonomous, or remotely controlled, and are operable to transport selected instances of food items between various locations, for example from one or more locations in the inventory 506 to one or more assembly locations. The robotic vehicle(s) 510 may, for example, have a table 510-1 on which containers (e.g., container, totes, pallets or shelves) are carried. The table(s) 510-1 may be vertically translatable to lift the container above the surface on which the container is placed. The table(s) 510-1 may additionally or alternatively be pivotable or rotatable about a vertical axis to reorient a container with respect to a body 510-2 of the robotic vehicle 510. The table(s) 510-1 may additionally or alternatively be pivotable or rotatable about a horizontal axis (as shown in FIG. 5) to tilt with respect to the body 510-2 of the robotic vehicle, allowing a container to be slid off of the robotic vehicle 510, for example into packaging. The robotic appendage(s) 512 may be driven via one or more actuators (e.g., electric motors, stepper motors, solenoids, pneumatic pistons, hydraulic pistons), and are operable to retrieve and transport selected instances of food items 505 and/or the associated container holding the instance of food item, between various locations, for example from one or more locations in the inventory 506 to one or more assembly locations, and/or to place the selected instances of food items 505 into suitable packaging.

The production subsystem 500 may include, or interact with, the inventory 506, illustrated as two sets of shelves 506-1, 506-2. In some implementations, the inventory 506 will include a large array of storage spaces, some or all of which may be temperature controlled so a plurality or shelf storage segments have identical or different temperatures from each other, the temperature control based at least in part of the attributes of the instances of food present in that shelf storage segment. Storage spaces can take any variety of form or forms, for instance warehouse shelves, racks, drawers, chests, pallets, refrigerated compartments, etc.

The production subsystem 500 may, for example, handle specific instances of a given type of food item differently based, at least in part, on the attributes of the instances of food items. For example, instances of fruits of a given type (e.g., apples, bananas) may be handled differently from one another based on a measure or assessment of ripeness. For instance, the instances of fruit may be treated or packaged differently, for example to maintain a variety of levels of ripeness in an inventory.

The production subsystem 500 or components thereof is or are operable to retrieve instances of food items 505 from the inventory 506 and to collate or assemble the instances of food 505 into orders. For example, the production subsystem 500 is operable to assemble instances of food items 505 into an assembly or collection of groceries and/or sundries 514. Also for example, the handling subsystem 500 is operable to assemble instances of food items 505 into an assembled food item or food product 516 or meal kit 518, which may or may not be prepared in some manner (chopped, cooked, etc.).

FIG. 5 depicts an illustrative arrangement of fulfillment system 600-1 comprising a control subsystem 602, order subsystem 604, production subsystem 606, and distribution subsystem 612, where the production subsystem 606 transfers assembled orders to the distribution subsystem 612, according to at least one illustrated implementation.

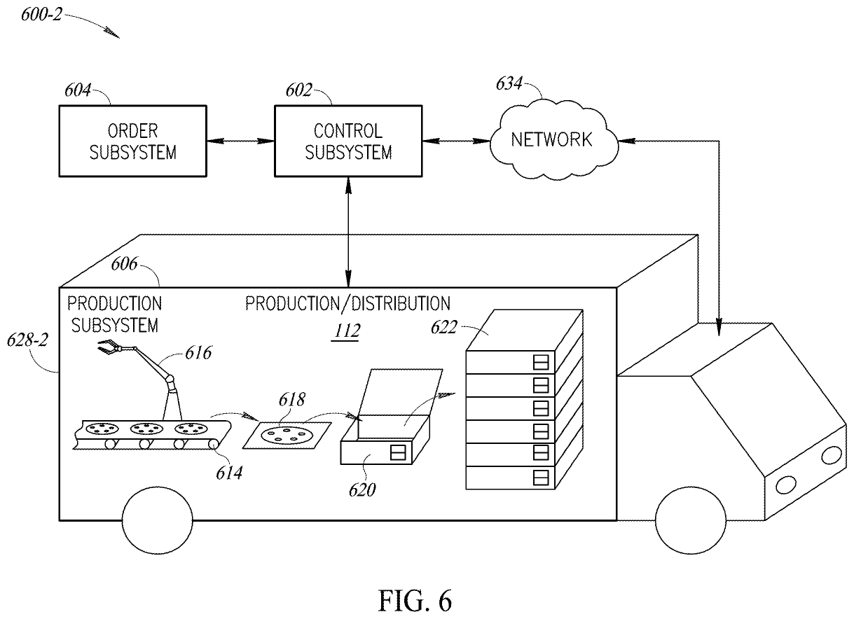

The controller subsystem 602 may control operation of, or inter-operation between, one or more of the order subsystem 604, production subsystem 606, and distribution subsystem 612. The order subsystem 604 may provide or provision a user interface that allows users to select individual instances of food items for an order, based on appearance and/or various attributes. The production subsystem 606 may retrieve selected instances of food items from an inventory (not shown in FIG. 6-1), and assemble the retrieved instances of food items into an order. For example, one or more mechanisms (e.g., conveyor 614, robot 616) may retrieve and move select instances of food items 618 to a container 620 (e.g., packaging, appliances). Also for example, one or more mechanisms (e.g., conveyor 614, robot 616) may move the packaging into an array 622, for instance on a rack 624 for transfer (arrow 626) to a component of the distribution subsystem (e.g., vehicle 628-1).

In some implementations, the food items 204 are loaded into appliances which can be placed in racks. The racks, each containing one or more individual appliances, are loaded onto delivery vehicles 628-1. While in transit to each of a number of consumer delivery or pickup locations, the preparation conditions within each of the appliances (e.g., time one, time off, temperature, speed selector, etc.) are adjusted to complete the food preparation process shortly before delivery or pickup of the food items 618 to or by the user. Various structures and methods from U.S. Pat. No. 9,292,889, U.S. patent application Ser. No. 62/532,885 and/or International patent application PCT/US2018/040714 may be employed. As noted above, one or more sensors may measure the instance of food item to determine an attribute, which information may be used to control the appliance, food preparation conditions, provided to the user, and/or estimated time of delivery, which may occur multiple times during the preparation process and/or delivery time.

In some implementations, the control subsystem 602 receives data indicative of one or more orders received by the order subsystem 604. The control subsystem 602 communicates the orders to the production subsystem 606. Within the production subsystem 606 orders are assembled. In some implementations, various instances of food items (e.g., ingredients) are selected, processed, combined, mixed, and assembled to produce an assembled food item per the order data received from the control subsystem 602. Specific parameters of the combination or mixing may be dictated by attribute information of the instances of food items and which may distinguish a one instance of a given type of food item from another. As discussed above, in some instances the order data may be generated by the control subsystem 102 either as a result of an actual received order or based on the occurrence of one or more events that are logically associated with the historical receipt of specific food item orders. In some implementations, the prepared or assembled food items are placed into individual appliances, for example prepared pizzas may be placed into individual ovens 210 for baking or cooking, either immediately or at a delayed and determined schedule time to start cooking. In some implementations, the control subsystem 602 is communicatively coupled to the distribution subsystem 612 or components thereof (e.g., vehicle 628-1, routing subsystem 630, preparation subsystem 632) via one or more communications channels (e.g., communications network 634), for example to provide order instructions, delivery instructions, preparation instructions and/or routing instructions.

FIG. 6 depicts an illustrative arrangement of fulfillment system 6002 comprising a control subsystem 602, order subsystem 604, production subsystem 606, and distribution subsystem 612, where the production subsystem 606 is co-located with the distribution subsystem 612, according to at least one illustrated implementation. The fulfillment system 600-2 of FIG. 6 is similar or even identical in some respects to fulfillment system 600-1 of FIG. 5. Similar or identical components or structures are identified using the same reference numbers in FIGS. 5 and 6. Only some of the notable differences are discussed below.

The production subsystem 606 may retrieve selected instances of food items from an inventory (not shown in FIG. 6) located on or in a vehicle 628-2, and assemble the retrieved instances of food items into an order. For example, one or more mechanisms (e.g., conveyor 614, robot 616) may retrieve and move select instances of food items 618 to a container 620 (e.g., packaging, appliances). Also for example, one or more mechanisms (e.g., conveyor 614, robot 616) may move the packaging into an array 622, for instance on a rack or pallet carried by the vehicle 628-2. As noted above, one or more sensors may measure the instance of food item to determine an attribute, which information may be used to control the appliance, food preparation conditions, provided to the user, and/or estimated time of delivery.

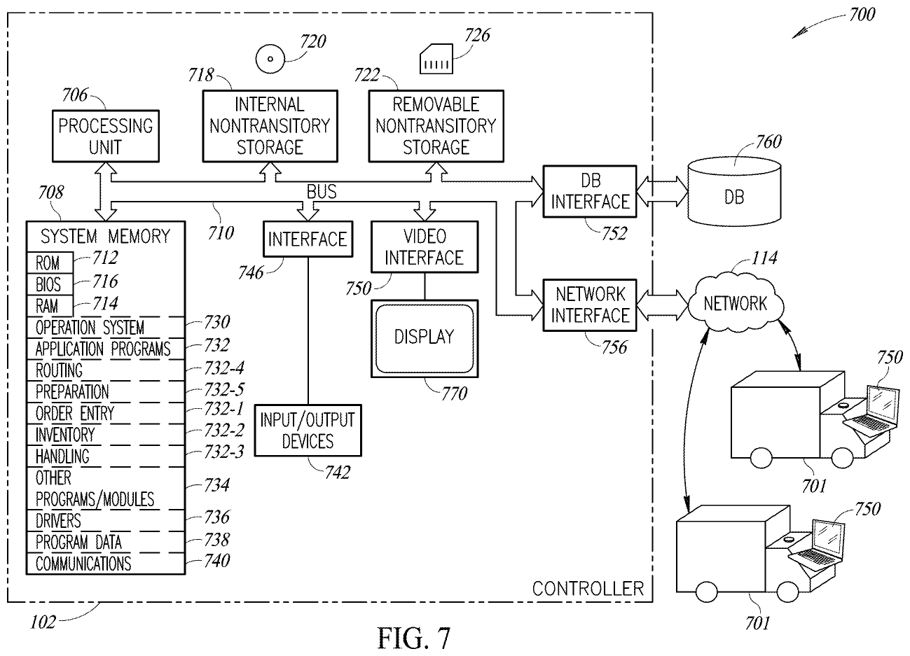

FIG. 7 and the following discussion provide a brief, general description of an exemplary processor-based system 700 that may be used to implement the control subsystem 102, 602, inventory management subsystem 103, 201-1, 201-2, order subsystem 104, 604 production subsystem 106, 502, 504, 606, and/or distribution subsystem 112, 612. For example, a respective instance of the processor-based system 700, configured with respective sets of processor-executable instructions or logic for executing the algorithms described herein, may implement the control subsystem, inventory management subsystem, order subsystem, production subsystem, and/or distribution subsystem.

Although not required, some portion of the implementations will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be stored in both local and remote memory storage devices and executed using one or more local or remote processors, microprocessors, digital signal processors, controllers, or combinations thereof.

The processor-based system 700 may take the form of any current or future developed computing system capable of executing one or more instruction sets. The processor-based system 700 includes a processing unit 706, a system memory 708 and a system bus 710 that communicably couples various system components including the system memory 708 to the processing unit 706. The processor-based system 700 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80×86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 series processor as offered by Apple Inc., or a 68xxx series microprocessor as offered by Motorola Corporation.

The processing unit 706 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 7 are of conventional design. As a result, such blocks need not be described in further detail herein, as they will be understood by those skilled in the relevant art.

The system bus 710 can employ any known bus structures or architectures, including a memory bus with memory controller, a peripheral bus, and a local bus. The system memory 708 includes read-only memory (“ROM”) 712 and random access memory (“RAM”) 714. A basic input/output system (“BIOS”) 716, which can form part of the ROM 712, contains basic routines that help transfer information between elements within the processor-based system 700, such as during start-up. Some embodiments may employ separate buses for data, instructions and power.

The processor-based system 700 also includes one or more internal nontransitory storage systems 718. Such internal nontransitory storage systems 718 may include, but are not limited to, any current or future developed persistent storage device 720. Such persistent storage devices 720 may include, without limitation, magnetic storage devices such as hard disc drives, electromagnetic storage devices such as memristors, molecular storage devices, quantum storage devices, electrostatic storage devices such as solid state drives, and the like.

The processor-based system 700 may also include one or more optional removable nontransitory storage systems 722. Such removable nontransitory storage systems 722 may include, but are not limited to, any current or future developed removable persistent storage device 726. Such removable persistent storage devices 326 may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 718 and the one or more optional removable nontransitory storage systems 722 communicate with the processing unit 706 via the system bus 710. The one or more internal nontransitory storage systems 718 and the one or more optional removable nontransitory storage systems 722 may include interfaces or device controllers (not shown) communicably coupled between nontransitory storage system and the system bus 710, as is known by those skilled in the relevant art. The nontransitory storage systems 718, 722, and their associated storage devices 720, 726 provide nonvolatile storage of computer-readable instructions, data structures, program modules and other data for the processor-based system 700. Those skilled in the relevant art will appreciate that other types of storage devices may be employed to store digital data accessible by a computer, such as magnetic cassettes, flash memory cards, Bernoulli cartridges, RAMs, ROMs, smart cards, etc.

Program modules can be stored in the system memory 708, such as an operating system 730, one or more application programs 732, other programs or modules 734, drivers 736 and program data 738.

The application programs 732 may include, for example, one or more machine executable instruction sets 732-1 capable of providing an order subsystem 104 able to cause a user interface to be provided, presenting information about instances of food items and to receive food item orders in any form of communication, including without limitation, voice orders, text orders, and digital data orders. The machine executable instruction sets 732-1 may implement or perform filtering of an inventory based on attributes (physical characteristics, determined classifications, predicted times of classification change, and other product information) which may be determined about any instance or multiple instance of food items, specified by a user or potential consumer, or may be derived based on previous food items or orders by the user or other users of like consumers, etc. The application programs 732 may additionally include one or more machine executable instruction sets 732-2 capable of preforming or maintaining an inventory that includes images and information about a plurality of instances of food items available for selection, for example including storing the images and information in non-transitory processor-readable media along with a logical association (e.g., unique identifier, point, field in a record) with the corresponding instance of food, and optionally employing a plurality of computers to implement a block chain infrastructure to establish provenance from farm to table for each instance of food item. The application programs 732 may additionally include one or more machine executable instruction sets 732-3 capable of controlling equipment and/or presenting prompts to retrieve and assemble or otherwise handle or process or prepare selected instances of food items and associated appliances. The application programs 732 may additionally include one or more machine executable instruction sets 732-4 capable of providing a routing subsystem 116 able to provide text, voice, and/or graphical routing instructions to the output devices 250 in some or all of the delivery vehicles 701. Such a routing subsystem machine executable instruction set may also be executable by one or more controllers in a routing subsystem 116 installed in some or all of the delivery vehicles 701. The application programs 732 may further include one or more appliance subsystem machine executable instructions sets 732-5 capable of outputting preparation instructions to the appliances in the cargo compartment 241 of each delivery vehicle 701.

Such preparation instructions 732-5 can be determined by the processor-based system 700 using any number of inputs including at least, the food type in a particular appliance and the available preparation time before each respective food item is delivered to a delivery destination or pickup location. Such an appliance module machine executable instruction set may be executed in whole or in part by one or more controllers in the appliance subsystem 118 installed in some or all of the delivery vehicles 701. In at least some instances, the routing subsystem 116 and/or the appliance subsystem 118 may provide a backup processor-based system 700 in the event processor-based system 700 becomes communicably decoupled from the delivery vehicle 701. In another implementation, the routing subsystem 116 and/or the appliance subsystem 118 installed in each delivery vehicle may include nontransitory storage to store routing and delivery itinerary data and preparation data communicated to the respective module by the processor-based system 700. The application programs 732 may, for example, be stored as one or more executable instructions.

The system memory 708 may also include other programs/modules 734, such as including logic for calibrating and/or otherwise training various aspects of the processor-based system 700. The other programs/modules 734 may additionally include various other logic for performing various other operations and/or tasks.

The system memory 708 may also include any number of communications programs 740 to permit the processor-based system 700 to access and exchange data with other systems or components, such as with the routing subsystem 116, appliance subsystem 118, and/or output devices 750 installed in each of the delivery vehicles 701.

While shown in FIG. 7 as being stored in the system memory 708, all or a portion of the operating system 730, application programs 732, other programs/modules 734, drivers 736, program data 738 and communications 740 can be stored on the persistent storage device 720 of the one or more internal nontransitory storage systems 718 or the removable persistent storage device 726 of the one or more optional removable nontransitory storage systems 722.

A user can enter commands and information into the processor-based system 700 using one or more input/output (I/O) devices 742. Such I/O devices 742 may include any current or future developed input device capable of transforming a user action or a received input signal to a digital input. Example input devices include, but are not limited to, a touchscreen, a physical or virtual keyboard, a microphone, a pointing device, or the like. These and other input devices are connected to the processing unit 706 through an interface 746 such as a universal serial bus (“USB”) interface communicably coupled to the system bus 710, although other interfaces such as a parallel port, a game port or a wireless interface or a serial port may be used. A display 770 or similar output device is communicably coupled to the system bus 710 via a video interface 750, such as a video adapter or graphical processing unit (“GPU”).

In some embodiments, the processor-based system 700 operates in an environment using one or more of the network interfaces 756 to optionally communicably couple to one or more remote computers, servers, display devices 750 and/or other devices via one or more communications channels, for example, one or more networks such as the network 114. These logical connections may facilitate any known method of permitting computers to communicate, such as through one or more LANs and/or WANs. Such networking environments are well known in wired and wireless enterprise-wide computer networks, intranets, extranets, and the Internet.

Further, the database interface 752, which is communicably coupled to the system bus 710, may be used for establishing communications with a database stored on one or more computer-readable media 760. For example, such a database 760 may include a repository for storing information regarding images and attributes of individual instances of food items, cooking conditions as a function of time, etc.

### Description of Operation

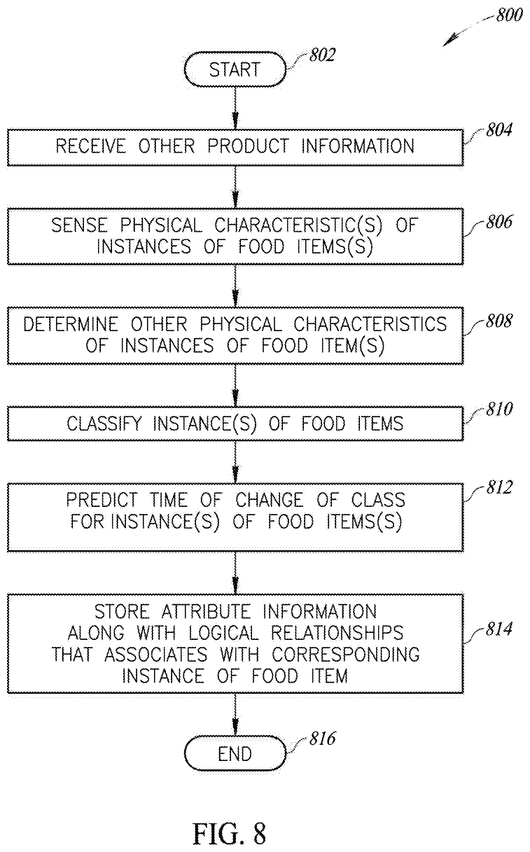

FIG. 8 shows a method 800 of operating a fulfillment system or portion thereof, according to at least one illustrated implementation. The method 800 may be employed with the fulfillment system 100 (FIG. 1) or various components or subsystems described herein for example the inventory subsystem 103 (FIG. 1).

The method 800 starts at 802, for example in response to powering on of one or more processor-based components or subsystems, or in response to a call or other invocation. In some implementations, the method may execute continually, performing fulfillment related activities 24 hours a day, seven days a week. The method 800 can execute as one or more threads on one or more processors of one or more processor-based devices or subsystems. For example, the method 800 may be employed to inventory a plurality of instances of food items, of one or more types of food items.

At 804, one or more processor based systems may receive other product information associated with an instance of food item. The other product information (e.g., expiration date, use by date, sell by date, price, location of storage or transit, source name, rating (Grade A; Premium), category (large, small, lean, fat, organic, natural, conventional, sourced locally, free range, cruelty free, gluten free, peanut free, low sodium, sugar free, low sugar, Kosher, Halal), etc.) may be received from any appropriate entity, such as a source farm or other entity within the food supply chain.

At 806, one or more invasive and/or non-invasive (e.g., image sensors or cameras, load cells, chemical compound detection sensors, microphones, pressure sensors, ultrasonic sensors, weight sensor, humidity sensors, etc.) to sense and/or determine physical characteristic(s) of a plurality of instances of food items of one or more types of food items. For example, one or more imaging systems may capture images of a plurality of instances of food items of one or more types of food items and may capture images from a plurality of perspectives about the instance of the food item. The imaging system may capture still images, moving images, black and white images, color images, and/or high resolution images. The instance of food item may be illuminated using artificial light, or any other appropriate technique to increase consistent color and shading. Additionally or alternatively, one or more sensors (e.g., scale, load cell) may capture or measure a weight of the instance of the food item. Also for example, one or more sensors (e.g., imager, laser dimensioning system or scanner) may capture or measure one or more spatial dimensions (e.g., length, width, height, circumference, periphery) of the instance of the food item. Also for example, one or more sensors (e.g., image sensors) may capture or measure a hue or hues of the instance of the food item. Also for example, one or more sensors (e.g., ultraviolet sensor) may capture or measure a non-visible spectral response of the instance of the food item to illumination by selected band(s) of wavelengths (e.g., ultraviolet). Also for example, one or more sensors (e.g., electronic noise) that are responsive to a presence or level of one or more chemical compounds (e.g. volatile chemical compounds, ethylene) may capture or measure a scent emitted by the instance of the food item. Also for example, one or more sensors (e.g., pH meter, pH paper) may capture or measure an acidity or alkalinity (pH) of the external and/or internal body of an instance of the food item. Also for example, one or more sensors (e.g., IR based moisture sensor, electrical resistance based moisture sensor) may capture or measure an external and/or internal moisture content of the instance of the food item. Also for example, one or more sensors (e.g., durometer, penetrometer, load cell and probe) may capture or measure a level of firmness/rigidity and/or compliance/resilience of the instance of the food item. Also for example, one or more sensors (e.g., roughness sensor: contact roughness sensor, probe roughness sensor that senses friction and/or vibration; non-contact roughness sensor, such as laser based roughness sensor) may capture or measure a surface roughness of the instance of the food item. Also for example, one or more sensors (e.g., acoustic transducer, microphone) may capture or measure an acoustic signature of the instance of the food item, for instance in response to being tapped or struck by an object or probe (e.g., piano hammer). Additional and alternative sensors and physical characteristics may be implemented as appropriate, such as those described above with respect to FIGS. 1 and 2.

At 808, one or more processor-based devices determine other physical characteristics or attributes for a plurality of instances of the food items, typically based on the attributes of the instance of food item, including the sensed physical characteristic(s) 806. For example, one or more processors may determine a density of the instance of the food item, for instance from the sensed weight and spatial dimensions. Also for example, one or more processors may determine luster (e.g., level of matte or shiny) of the instance of the food item. For instance, a pattern (e.g., structured light) may be projected, and a processor may assess the light returned from the instance of the food item to determine how sharp or blurry the pattern appears. Also for example, one or more processors may determine the amount or ratio or distribution of marbling from the image(s) of the instance of the food item captured by the image sensor(s) (e.g., cameras). For instance, a processor may determine a ratio and/or distribution of pixels in the images having hues that correspond to fat to pixels having hues corresponding to meat (e.g., muscle). Also for example, one or more processors may determine a crispness of the instance of the food item. For instance, a processor may determine the crispness based on a captured or measured temperature, sound and/or moisture content of the instance of the food item. For instance, a sharp sound and/or low moisture content may correspond to a crisp instance of a food item, while a dull sound and/or high moisture content may correspond to a not crisp or even soggy instance of a food item. Also for example, one or more processors may determine a ripeness of an instance of the food item based on one or more of the attributes of the instance of food item. For example, the processor-based device may compare a value of the physical characteristic to a threshold value or range of threshold values, for one or more of the physical characteristics. For instance, the processor-based device may assess one, two or more of the physical characteristics (whether directly measured or determined—e.g., hue, luster, firmness, scent, sound, pH, moisture content) to assess a level of ripeness. In another example. The viscosity or other physical characteristic of the instance of food item may be measured to determine if the beverage is appropriately mixed/blended, or other state of preparedness.

Classifications may take any of a variety of forms. A non-limiting set of example categories includes: large; small; lean; fat; ripe, unripe, over ripe, rare, medium, well, uncooked, cooked, chilled, unchilled, prepared, unprepared, high fat, low fat, localized marbling, extensive marbling, various yield grades, various quality grades. The processor based device may compare one or more attributes of the instance of food item against thresholds for various classifications to classify the instance of food item. For example, the amount and/or distribution of marbling may be determined based on the image hues of the instance of food item. The physical characteristics of the instance of food item may be compared against different thresholds of the used to determine the yield grade of the meat and/or cut or quality grade. Additionally or alternatively to determining the yield grade and/or quality grade, the determined physical characteristic may be used to validate and/or verify a yield and/or quality grade received in the other product information.

At 810, the processor-based device may classify instances of food items into one or more classes or classifications. For example, classes or classification may include a current level of ripeness, state of doneness, etc.

At 812, for a determined classification of an instance of food item, the processor-based device may predict a time of change to another classification. For example, based on the determined classification, the time of change to another classification may be determined such as based on a current level of ripeness, the time to change to another level of ripeness may be determines (for change from unripe to ripe, from ripe to over ripe). Additionally or alternatively, based on appliance parameters (e.g., temperature, time on, etc.) the time of classification change from raw to rare, medium, well done may be determined—or more simplistically, tie from raw to cooked or done. Additionally or alternatively, the time of change from an unmixed class to a mixed state may be predicted.

At 814, for an instance of the food item, a processor-based device stores the attribute information (information and value(s) representing sensed physical characteristic(s), determined physical characteristics, determined classification, predicted time of change classification, and/or other product information) along with one or more logical relationships (e.g., identifier(s), pointer(s), fields in records, other date structures) that identifies the corresponding instance of the food item.

The method 800 may terminate at 816 until called or invoked again. Alternatively, the method 800 may run continuously or periodically or from time-to-time, and may run as separate threads on a multi-threaded processor.

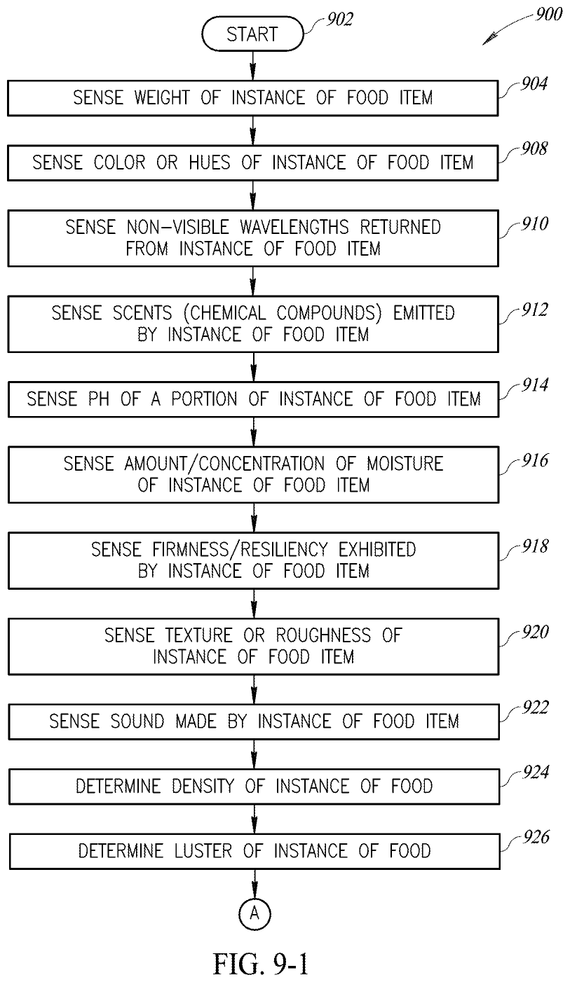

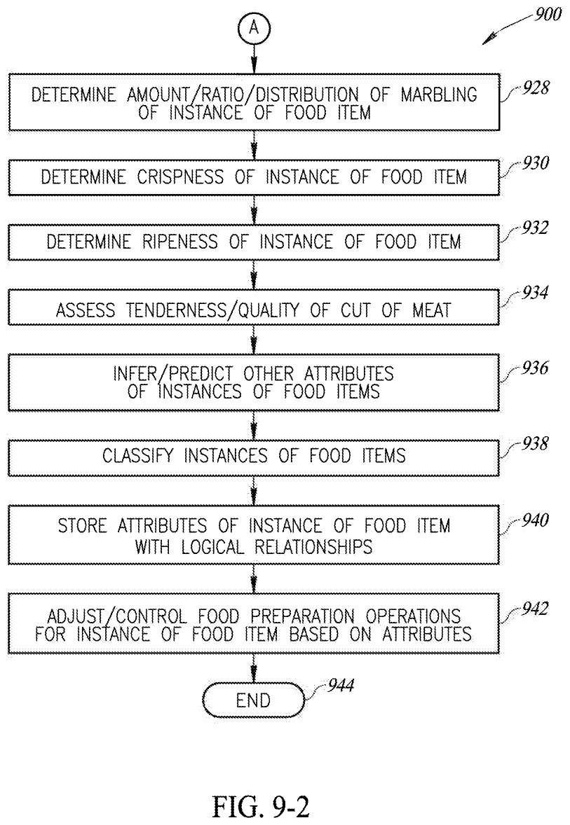

FIGS. 9-1 and 9-2 show a method 900 of operating a fulfillment system or portion thereof, according to at least one illustrated implementation. The method 900 may be employed with the fulfillment system 100 (FIG. 1) or various components or subsystems described herein for example the inventory subsystem 103 (FIG. 1) or control subsystem 102.

The method 900 may employ various sensors to sense and/or determine certain physical characteristics for respective instances of food items. For example, sensors may sense or measure: images, weight, size or spatial dimensions, color, non-visible wavelengths of electromagnetic energy, scent (volatile chemical compounds), pH, moisture content, resistance to pressure or force, tactile or surface roughness, and/or sound. As illustrated in FIGS. 9-1 and 9-2, the sensed information may be used to determine one or more characteristics for respective instances of food items. For example, density and/or surface luster can be determined from the sensed physical characteristics. The sensed physical characteristics and/or the characteristics determined therefrom can be used to determine other characteristics of the instances of food items, for example: an amount, ratio and/or distribution of marbling, a level or ripeness, a crispness.

The method 900-1 starts at 902, for example in response to powering on of one or more processor-based components or subsystems, or in response to a call or other invocation. In some implementations, the method may execute continually, performing fulfillment related activities 24 hours a day, seven days a week. The method 900-1 can execute as one or more threads on one or more processors of one or more processor-based devices or subsystems. For example, the method 900-1 may be employed to inventory a plurality of instances of food items, of one or more types of food items.

At 904, one or more sensors (e.g., scale, load cell) captures, senses or measures a weight of the instance of the food item. The weight may be represented in any convenient units, for instance, ounces, pounds, grams, or kilograms.

At 906, one or more sensors (e.g., laser dimensioning system) captures, senses or measures a size or spatial dimensions of the instance of the food item. The spatial dimensions may be represented in any convenient units, for instance, inches, millimeters, or centimeters.

At 908, one or more sensors (e.g., image sensor(s), camera(s)) captures, senses or measures one or more colors or hues of the instance of the food item from the image(s) of the instance of the food item captured by the sensor(s). For example, the hue may be represented in the form of levels of red, green, blue for one or more pixels.

At 910, one or more sensors (e.g., ultraviolet sensor(s), camera(s)) captures, senses or measures one or more non-visible wavelengths of electromagnetic energy returned from the instance of the food item.

At 912, one or more sensors (e.g., electronic nose, chemical compound sensor(s)) senses one or more scents as represented by the presence of certain chemical compounds emitted by the instance of the food item captured by the sensor(s). For example, scent may be represented as a simple presence/absence indication or by an amount or concentration.

At 914, one or more sensors (e.g., pH testing probe equipment) senses a pH of a portion of the instance of the food item.

At 916, one or more sensors (e.g., infrared based, hyperspectral, or electrical resistance based moisture sensor, e) senses a value that represents an amount or concentration of moisture of the internal and/or external instance of the food item.

At 918, one or more sensors (e.g., durometer, penetrometer) captures, senses or measures a hardness or resistance to force or pressure exhibited by the instance of the food item.

At 920, one or more sensors (e.g., roughness sensor, contact roughness sensor, probe roughness sensor that senses friction and/or vibration; non-contact roughness sensor, such as laser based roughness sensor) captures, senses or measures a value the is representative of surface texture or roughness of the instance of the food item.

At 922, one or more sensors (e.g., acoustic transducer, microphone) captures, senses or measures sounds made by the instance of the food item, for example in response to being tapped or struck by an object (e.g., piano hammer). The sound may be indicative of a density of the instance of the food item and/or a crispness of the instance of the food item.

As noted above, a processor-based device may assess the various captured, sensed or determined physical characteristics to determine additional attributes of, or information about, the instance of food product, and/or to classify the instance of food product in one or more classifications. Some examples follow.

At 924, a processor-based device determines a density of the instance of food item, for example by dividing a weight by a volume (e.g., spatial dimensions) occupied by the instance of the food item or via determining a fluid displacement caused by the instance of the food item.

At 926, a processor-based device determines a luster of the instance of the food item, for example from the image(s) of the instance of the food item captured by the sensor(s) (e.g., image sensors, cameras). For example, the processor-based device may determine whether a pattern projected (e.g., structure light) onto the instance of the food items is returned as a sharp reflection (e.g., specular reflection)) or as a blurry image (e.g., diffuse reflection). For instance, the processor-based device may determine where a reflection from an exterior surface of the instance of the food item falls on a scale from shiny to matte for one or more pixels based on the reflected light.

At 928, a processor-based device determines an amount or ratio and/or distribution of marbling of the instance of the food item (e.g., cut of meat). For example, the processor-based device may determine the amount or ratio or distribution of marbling from the image(s) of the instance of the food item captured by the image sensor(s) (e.g., cameras). For example, the processor-based device may determine a ratio and/or distribution of pixels in the images having hues that correspond to fat to pixels having hues corresponding to meat (e.g., muscle).

At 930, a processor-based device determines a crispness of the instance of the food item. For example, the processor-based device may determine the crispness based on a captured or measured sound and/or moisture content of the instance of the food item. For instance, a sharp sound and/or low moisture content may correspond to a crisp instance of a food item, while a dull sound and/or high moisture content may correspond to a not crisp or even soggy instance of a food item.

As noted above, a processor-based device may assess the various physical characteristics along with various determined additional attributes of, or information about, the instance of food product, to determine an even high level of attributes or information and/or to classify the instance of food product in one or more classifications. Some examples follow.

At 932, a processor-based device determines a ripeness of an instance of the food item based on one or more of the sensed attributes of the instance of food item. For example, the processor-based device may compare a value of the attribute to a threshold value or range of threshold values, for one or more of the attributes. For instance, the processor-based device may assess one, two or more attributes to assess a level of ripeness or predicts a number of days or hours until the instance of the food item will transition from an unripe classification to be a ripe classification. Also for instance, the processor-based device may assess one or more of the attributes to assess spoilage or a level of decay or predict a number of days or hours until the instance of the food item will change classification from fresh to be a spoiled classification. Many types of food will have a certain hue when ripe, e.g., for example bananas may be mostly yellow with some light brown patches. Many fruits will have a certain luster when ripe or fresh, for may be relatively firm but not hard when ripe (e.g., banana) or may be very soft when ripe (e.g., passion fruit). Some fruits (e.g., melons, pineapples) will have make a distinctive sound when ripe but not when unripe. Fish will tend to have high luster, be relatively firm or resilient, and have a sea type scent when fresh, but will be dull, soft and not resilient and have a fishy scent when not fresh.

At 934, the processor-based device may assess one or more of the attributes to classify a tenderness or quality level of a cut of meat (e.g., Grade A steak). For instance, fat marbling on a ribeye steak can correlate with an amount or level of tenderness of the cooked steak. Also for instance, a relatively low moisture content may indicate that a steak has been properly dry-aged for an extended period of time, again being an indicator of tenderness.

At 936, one or more processor-based devices may, for example employ a prediction model or otherwise infer or predict other attributes of the instances of food items that may be relevant to a specific user, group of users, or that may be relevant to further handling or preparation of the food items. For example, one or more processor-based devices may use trained or machine-learning computer models to correlate objective physical characteristics with properties that cannot be directly observed but may be inferred or predicted. For instance, hyperspectral imaging data can correlate with a moisture content of a food item. Also for instance, fat marbling and/or moisture content of a ribeye steak can correlate with an amount or level of tenderness of the cooked steak. Thus, one or more processor-based devices may, for example, infer or predict one or more attributes of a cooked or prepared food item based, at least in part on, the physical characteristics of the raw or unprepared food item (e.g., predicting an outcome of heat, cooking, cooling or even freezing an item of food) and/or other determined attributes of or information about the instances of food items.

At 938, a processor-based device classifies the instance of the food item based on the attributes. For instance, the processor-based may classify an instance of a food item (e.g., piece of fruit, vegetable) as being not ripe, ripe, or over ripe.). Also for instance, the processor-based may classify an instance of a food item (e.g., piece of fruit, vegetable, meat, poultry, fish, milk, eggs) as being not spoiled, close to spoiled, or spoiled. For instance, the processor-based may classify an instance of a food item (e.g., cut of meat) as being Grade A, Grade B, etc. For instance, the processor-based may classify an instance of a food item as being prime or not prime. Any appropriate classification may be determined and/or predicted as appropriate for the type of food item.

At 940, a processor-based device stores the attributes of the instance of the food item to one or more nontransitory processor-readable media along with a logical relationship between the instance of the food item and the attributes.

At 942, one or more processor-based devices may employ the attributes in adjusting or controlling one or more food preparation operations for the instance of the food item. For instance, a cooking profile may be adjusted based on a moisture content and/or an amount of marbling, with executable instructions sent to a cooking appliance to automatically control the cooking. Thus, cooking conditions could be altered based on the actual physical characteristics and/or other attributes. For example, a first instance of a first food type may require more or less cooking than a second instance of the first food type, where the first instance has a higher moisture content, larger size, level of ripeness, etc. then the second instance of the same food type. Also for example, a first instance of a first food type may require a different cooking profile (e.g., temperature over time) than a second instance of the first food type, where the first instance has a ratio or distribution of marbling then the second instance of the same food type.

The method 900 may terminate at 944 until called or invoked again. Alternatively, the method 900 may run continuously or periodically or from time-to-time, and may run as separate threads on a multi-threaded processor.

FIG. 10 shows a method 1000 of operating a fulfillment system or portion thereof, according to at least one illustrated implementation. The method 1000 may be employed with the fulfillment system 100 (FIG. 1) or various components or subsystems described herein for example the inventory subsystem 103 (FIG. 1) or control subsystem 102.

At 1002, a processor-based device determines a level or amount of ripeness of an instance of a food item. For example, the processor-based device may assess one, two or more of the physical characteristics to assess a level or amount of ripeness (e.g., ripe or not; number of days or hours until the instance of the food item will be ripe; number of days or hours until the instance of the food item will be over-ripe. For example, the processor-based device may assess a visual appearance of the instance of the food time. For instance, the processor-based device may assess whether the food item or portion thereof (e.g., skin) is smooth and taut or alternatively wrinkled or saggy. As an example, many types of food items are taut and smooth while ripe (e.g., apples) while others are wrinkled or saggy (e.g., passion fruit). Also for instance, the processor-based device may assess a hue of the instance of the food item (e.g., green; yellow, or brown; solid or consistent hue; speckled, spotted or inconsistent hue) As an example, bananas often have a greenish tinge when unripe, and are yellow with some brown spots when ripe, and black when over-ripe. Also for instance, the processor-based device may assess a luster of the instance of the food item (e.g., shinny; matte). Also for instance, the processor-based device may assess a level of firmness or rigidity or compliance or resilience of the instance of the food item. As an example, the flesh of fresh fish is resilient and rebounds back when lightly pressed. As another example, unripe avocados are unyielding, while ripe avocados will yield slight under pressure. Also for instance, the processor-based device may assess a scent of the instance of the food item. As an example, certain fruits (e.g., apples) emit ethylene when ripe. These chemical compounds can be detected with various sensors that are responsive to certain chemical compounds. Assessment may in some implementations be based on the simple presence or absence of the trait chemical compound(s), while the assessment in other implementations may be based on a level, amount or concentration of the trait chemical compound(s). Also for instance, the processor-based device may assess a sound made by the instance of the food item, for example when tapped or thumped. As an example, a ripe melon can be assess based on a distinctive hollow sound made when tapped or thumped.

At 1004, at least one processor-based device stores an indication of ripeness in nontransitory processor-readable media along with a logical relationship to the corresponding instance of the food item.

FIG. 11 shows a method 1100 of operating a fulfillment system or portion thereof, according to at least one illustrated implementation. The method 1100 may be employed with the fulfillment system 100 (FIG. 1) or various components or subsystems described herein for example the order subsystem 104 (FIG. 1) or control subsystem 102 (FIG. 1).

The method 1100 starts at 1102, for example in response to powering on of one or more processor-based components or subsystems, or in response to a call or other invocation. In some implementations, the method may execute continually, performing fulfillment related activities 24 hours a day, seven days a week. The method 1100 can execute as one or more threads on one or more processors of one or more processor-based devices or subsystems. For example, the method 1100 may be executed by the control subsystem 102 or order subsystem 104 to cause a user interface to be provided which allows a user or consumer to inspect each instance of a food time individually and select only those that meet the user or consumer's standards or desires.

At 1104, at least one processor-based device causes a user interface to be presented that includes one or more types of food items which may be selected. The types of food items may identify a category of food items at any of one or more hierarchical levels. For example, an initial level may provide user-selectable icons corresponding to fruits, vegetables, meats, fish, dairy, grains, and legumes. Selection of a top level category may cause presentation of a (context sensitive) lower level category. For example, selection of meats may cause presentation of a set of user-selectable icons corresponding to beef, pork, chicken, mutton. Further nested levels may be presented, for instance different cuts of beef.

In some implementations, a control subsystem or order subsystem may provide the user interface to a user or consumer operated end user device, for instance as a Webpage or Website, or may provide information for populating portions of the user interface. In other implementations, an application executing on a user operated end user device may cause the presentation. That application may, in some instances, receive information (e.g., updated list of available types of food items) from the control subsystem or order subsystem.

At 1106, at least one processor-based device receives one or more inputs that identify a selection of one or more types of food items. The selections may be received, for example, as get or request commands from a Webpage, or as a user selection via an application executing on a processor-based device operated by a user or consumer.

Optionally at 1108, at least one processor-based device causes a user interface to be presented that includes one or more user input interfaces (e.g., drag down menu, slide bars, set of radio buttons or data entry field) to receive desired attributes that the user or consumer desires in the food items for selection by the user. The presented attributes may be context sensitive, that is a first set of desired attributes may be presented for a first type of food item, while a second set of desired attributes, different than the first set of desired attributes, may be presented for a second type of food item. For example, a user input interface may be presented to specify a desired amount or ratio of marbling where the selected type of food item is beef, while such would not be presented where the selected type of food item is fruit or vegetable. Also for example, a user input interface may be presented to specify a desired amount or level of ripeness, while such would not be presented where the selected type of food item is meat or fish. Attributes may be specified as a specific value (e.g., 1 kilogram) or range of values (e.g., 2-3 days from being ripe) or a category (e.g., Grade A).

In some implementations, a control subsystem or order subsystem may provide the user interface to a user or consumer operated end user device, for instance as a Webpage or Website, or may provide information for populating portions of the user interface. In other implementations, an application executing on a user operated end user device may cause the presentation. That application may, in some instances, receive information (e.g., updated list of available attributes to select from) from the control subsystem or order subsystem.

While presenting a user interface to select desired attributes is illustrated as a separate operation from presenting a user interface to select a desired type of food item, some implementations may combine these operations, for instance presenting a user interface from which both the type of food item and the attributes are specified, for example simultaneously or concurrently. Alternatively, some implementations may omit the specification of the desired attributes, relying on the user or consumer to later pick or select those individual instances of food items having the physical attributes that the user or consumer desires.

At 1110, at least one processor-based device receives one or more inputs that identify one or more desired attributes for the selected type of food items. The selections may be received, for example, as get or request commands from a Webpage, or as a user selection via an application executing on a processor-based device operated by a user or consumer.

At 1112, at least one processor-based device identifies a set of instances of food items that meet a set of specified criteria. For example, at least one processor-based device may identify, from at least one data store, a set of instances of food items based at least in part on the at least one input, the set comprising a plurality of instances of food items that are each respective actual items of food that are vendable from at least one inventory of instances of food items. The criteria may include a specified type of food item and/or one or more specified attributes that the instance of food item should possess. Identification can include a query on a dataset using any of a variety of query approaches, including identifying exact matches, identifying one or more tuples, or approximate matches via an application of fuzzy logical. For instance, each of the available instances of food items may be represented via a data record in a data store (e.g., SQL database) with corresponding values for one or more attributes that the respective instance of food item possesses. Other types of data stores and query mechanisms and approaches may be employed.

At 1113, for the instances of food items in the set of instances of food items, at least one processor-based device retrieves, from at least one data store, previously stored attribute information about the instances of food items in the set of instances of food items. The previously stored information may be determined and stored upstream in the supply chain process, for example at a farm, during transport to a warehouse or other fulfillment center, and may be updated from time to time by the fulfillment system until further preparation, sale, and/or delivery. The storing of the information is typically independent of, and not responsive to, specific selections or inputs provide by end users. As part of retrieval, at least one processor-based device may, for the instances of food items in the set of instances of food items, at least temporarily prevent any further identifying of the respective instances of food items in response to a subsequent first input, until a termination criteria is reached. For example, at least one processor-based device may update a value of a field or a record or set a flag logically associated with the corresponding instance of food item in a data store. The flag or a value of a field of a record may be set to prevent any given instance of food items from being presented to two or more different end users or consumers during overlapping time periods. The flag or value of the field may be reset to indicate that the instance of the food item is available in response to the end user picking other instances of food items, or placing an order, or rejecting the instance of the food item, or failing to make a selection within a defined period of time.

At 1114, at least one processor-based device causes a presentation of attribute information about a number of instances of food items in the identified set of instances of food items that meet the specified criteria. The information may include one or more still or moving images or (captured from) of each of the instances of food items. The information may include one or more values of one or more of the physical attributes measured or determined from of each of the instances of food items, determined classifications and/or predicted time to change of classification and other product information. Advantageously, the images and the values represent the instance of food item, not some exemplary or model item of food. The presented attribute information may establish or represent a provenance for the instance of a food item, including for instance a place and/or date of origin, a list of nutrients, other growing conditions, proof of having been grown organically, etc. The presented attribute information may include information about the instance of food item through a supply chain, for example from farm to table, or from farm to the time at which the instance of the food item is presented to be selected or ordered, or is otherwise incorporated or assembled into a prepared food item. Where an assembled or prepared food item is presented to be ordered, the presentation may include information about a plurality of specific ingredients in the assembled or prepared food item, for instance the provenance of ingredient and/or certification (e.g., organically grown) and/or the history of the ingredients and the handling of the same as each ingredient traversed the supply chain. It is to be appreciated that any portion or combination of appropriate attribute information may be selectively presented to the user. For example general physical characteristics of the instance of food item may be presented along with user input interface to provide more detailed and/or further attribute information if desired for presentation by the user. Each instance of food item may be presented as a user-selectable link, selection of which adds the respective instance of food item to an electronic shopping cart for ordering by the user or consumer. In some instances, a still or moving image of the instance of the food item may be the user-selectable link.

In some implementations, a control subsystem or order subsystem may provide a user interface with the information to a user or consumer operated end user device, for instance as a Webpage or Website, or may provide the information for populating portions of the user interface. In other implementations, an application executing on a user or consumer operated end user device may cause the presentation of the information. That application may, in some instances, receive the information (e.g., images, values of physical attributes) from the control subsystem or order subsystem.

At 1116, at least one processor-based device receives an indication of a selection of one or more instances of food items. The selections may be received, for example, as get or request commands from a Webpage, or as a user selection via an application executing on a processor-based device operated by a user or consumer.

At 1118, at least one processor-based device causes the instances of the food items selected or ordered by the user or consumer to be retrieved to fulfill order. For example, the control subsystem or order subsystem may send commands or orders to a handling subsystem 103 (FIG. 1). Also for instance, for each of the instances of the food items identified by the selection, the control subsystem or order subsystem may automatically provide a unique identifier that is logically associated with the respective instance of the food items in at least one data store, allowing the instance of food item or tote carrying the same to be retrieved, sorted, packed and presented for pickup or delivery. In response, the production subsystem may automatically and/or manually retrieve the specific selected or ordered instances of food items, for collation of assembly into an order for delivery or pickup.

The method 1100 may terminate at 1120 until called or invoked again. Alternatively, the method 1100 may run continuously or periodically or from time-to-time, and may run as separate threads on a multi-threaded processor.

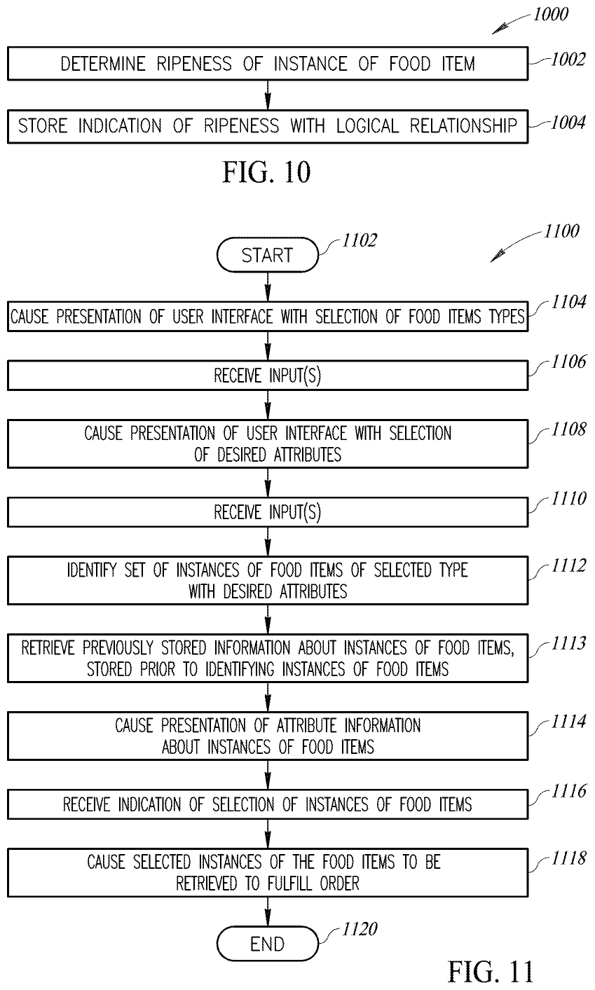

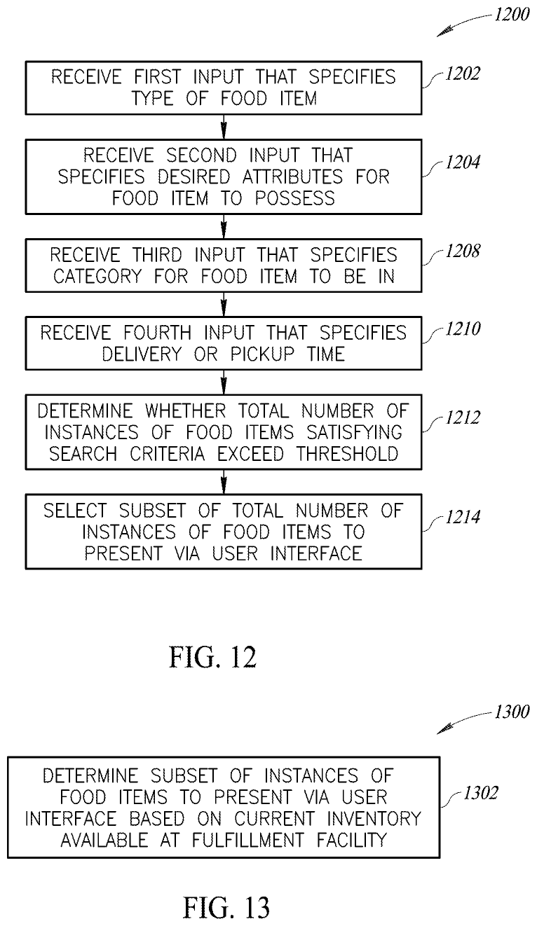

FIG. 12 shows a method 1200 of operating a fulfillment system or portion thereof, according to at least one illustrated implementation. The method 1200 may be employed with the fulfillment system 100 (FIG. 1) or various components or subsystems described herein for example the order subsystem 104 (FIG. 1) or control subsystem 102 (FIG. 1). In some implementations, the method 1200 can be performed as part of the performing the method 1100 (FIG. 11).

At 1202, at least one processor receives a first set of inputs that specifies a type of food item desired by a user. As previously explained, the first input can be received by, for example a server computer, via a Webpage or a dedicated application executing on a processor-based device operated by the user or consumer.

At 1204, at least one processor receives a second set of inputs that specifies values or ranges for one or more attributes that the user or consumer desires in instances of the food item of the selected type of food item. For example a the second set of inputs may include a sensed or determined value or range of physical characteristics. In some cases, the second set of inputs may include a third input indicating a classification of the instance of food item desired by the user. For instance, a user or consumer may seek organic foods, that are sourced locally and/or ripe fruit or fruit that will be ripe within 3 days.

Optionally at 1208, at least one processor receives a fourth set of inputs that specifies a date and/or time that is desired for deliver or pickup of selected instances of the food items. For instance, a user or consumer may want to have an order delivered or ready to be picked up within an hour, the next day, etc.

At 1210, at least one processor identifies a set of instances of food items satisfying the search criteria (e.g., specified type of food item, specified attributes). As previously discussed, such can be accomplished via one or more queries of a data set.

At 1212, at least one processor determines whether a total number of instances of food items satisfying the search criteria exceed a threshold number. In some instances, the total number of instances of food items that satisfy the criteria may be too large to present. A threshold may be fixed (e.g., 10, 24) or may vary based on various factors, including previous viewing and ordering history by the user or consumer, cost of the food items, etc.

At 1214, at least one processor selects a subset of the total number of instances of food items that satisfy the criteria to present to the user via a user interface. The total number selected for the subset and the composition of the subset can be based on a variety of factors. The total number may, for example depend on there may be too many instances of food items to display given constraints on display size, font size, communications bandwidth, or simply concerns over user or consumer fatigue, taking into account the desire to display a resolution image of the instances of the food items.

Additionally or alternatively, the composition of the subset may depend, at least in part, on a composition of an inventory from which the order will be fulfilled. For example, the composition of the subset may be based on a desire to transfer certain ones of the instances of food items out of inventory. For example, instances of food items that are approaching a spoilage deadline may be included in the subset, while instances of food items that further away from a respective spoilage deadline may be omitted from the subset. Also for example, instances of food items that are over-represented in an inventory may be included in the subset, while instances of food items that are under-represented in the inventory may be omitted from the subset. For instance, where an amount or ratio of marbling was not specified and where there is a relatively smaller number of highly marbled steaks of a particular cut than lowly marbling steaks of the particular cut, the subset may include only or mostly lowly marbled steaks of the particular cut. Additionally or alternatively, a price of the respective instances of food items may be automatically adjusted at least in part, on a composition of an inventory from which the order will be fulfilled. For example, where there are relatively few instances of sirloin steaks with a first level of marbling relative to a number of instances of sirloin steaks with a second level of marbling in the inventory, at least one processor may automatically adjust one or more prices such that the sirloin steaks with the first level of marbling is more costly that the instances of sirloin steaks with the second level of marbling.

FIG. 13 shows a method 1300 of operating a fulfillment system or portion thereof, according to at least one illustrated implementation. The method 1300 may be employed with the fulfillment system 100 (FIG. 1) or various components or subsystems described herein for example the order subsystem 104 (FIG. 1) or control subsystem 102 (FIG. 1). In some implementations, the method 1300 can be performed as part of the performing the method 1200 (FIG. 12).

At 1302, at least one processor determines a subset of instances of food items to present via user interface based on current inventory available at a fulfillment facility. For example, one or more previously selected instances of food items for an order may be fulfillable from respective inventories a defined set of fixed (e.g., warehouses, kiosks) or mobile (e.g., trucks) fulfillment facilities. When a subsequent type of food item and physical attributes are selected, the subset presented may be composed entirely or in part by instances of food items currently available in the same or proximate inventory of one or more of the fulfillment facilities of the previously defined set of facilities for fulfilling the order. The inventory can be updated dynamically, for instance in real time. The updated inventory can account for instances of food items already delivered or picked up. The updated inventory can account for instances of food items allocated to other orders, whether or not actually already delivered or picked up. This approach can advantageously can maximize the likelihood of being able fulfill a complete order via a single facility, for example allowing a single truck that may already be deployed to fulfill a complete order.

Additionally or alternatively, a price and or estimate time to availability (e.g., time to delivery, time to pick up) may be adjusted based on availability in an inventory of an instance of a product that meets a set of specified criteria, and presented to the user or potential user. Thus, a user may change one or more criteria (e.g., level of ripeness) for one or more food items in order to receive a discount and/or faster delivery or availability for pick up.

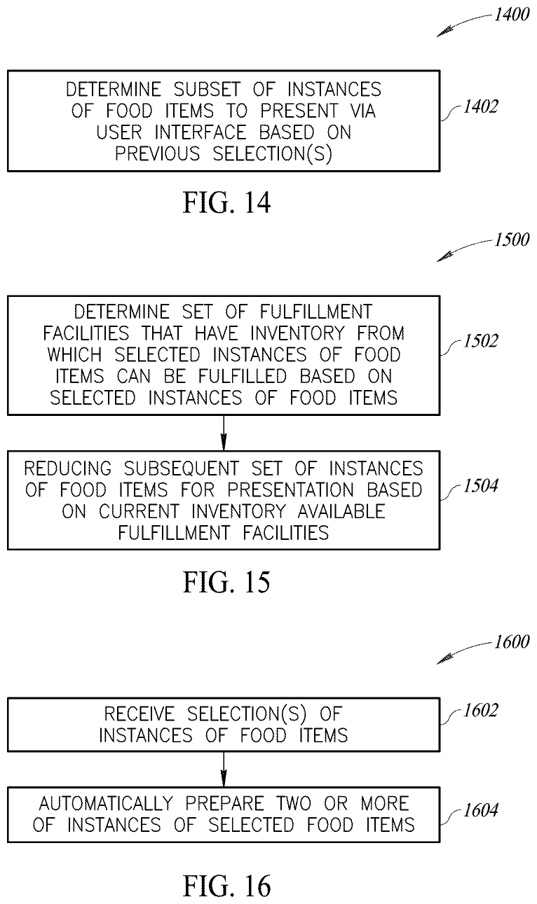

FIG. 14 shows a method 1400 of operating a fulfillment system or portion thereof, according to at least one illustrated implementation. The method 1400 may be employed with the fulfillment system 100 (FIG. 1) or various components or subsystems described herein for example the order subsystem 104 (FIG. 1) or control subsystem 102 (FIG. 1). In some implementations, the method 1400 can be performed as part of the performing the method 1200 (FIG. 12).

At 1402, at least one processor determines a subset of instances of food items to present via a user interface based on one or more previous selections made by the user. For example, the processor may determine that previous selections by the user fit a pattern. The pattern may display a preference for certain attributes, for example a tendency to select under-ripe items, certain cuts of meat, and/or certain sizes. The processor-based device may limit its use of previous attribute selections to the same type of food items. For example, previous selections of a quality grade of meat may be limited to use in generating a subset of instances of meat for a subsequent order or for subsequent selections within a given order. The processor-based device may make use of previous attribute across different types of food. For example, previous selections of a level of ripeness for bananas may be used in generating a subset of instances of avocados for a subsequent order or for subsequent selections within a given order.

Determining a subset of instances of food items to present or “filtering” choices may be pre-applied based on data from learned user behavior, either the behavior a specific user or the behavior of groups of users (e.g., grouped based on region, neighborhood, A/B testing groups). The behavior may be determined heuristically, may be machine learned, or may be business defined. This filtering may be applied by correlative behavior grouping (e.g., users who buy green apples typically prefer green bananas). This filtering could be applied by “basket” correlations (e.g., fish and chips in per-person meal proportions. Where two fish filets are selected, recommend a corresponding weight of potatoes for making chips that serve two people).

FIG. 15 shows a method 1500 of operating a fulfillment system or portion thereof, according to at least one illustrated implementation. The method 1500 may be employed with the fulfillment system 100 (FIG. 1) or various components or subsystems described herein for example the destination subsystem 112 (FIG. 1) or control subsystem 102 (FIG. 1). In some implementations, the method 1500 can be performed as part of the performing the method 1100 (FIG. 11).

At 1502, at least one processor determines a set of fulfillment facilities that have respective inventories from which the selected instances of food items can be fulfilled based on the user or consumer selections of instances of food items. For example, the processor may query a data set that stores a current inventory maintained at various fulfillment facilities. For instance, a fleet of delivery vehicles may be deployed, circulating in various neighborhoods. A data set may maintain a respective current inventory available on a plurality of vehicle that is not already committed to an order. The processor may query the data set for one or more vehicles within a defined range or proximate a defined location (e.g., delivery location) that has the type and number of instances of food items in the inventory. The query may locate one or more vehicles with suitable inventory and a current position or route that can satisfy the order.

At 1504, at least one processor reduces a subsequent set of instances of food items for presentation based on a current inventory available at the fulfillment facility or facilities. For example, the processor may update the data store to indicate that selected instances of food items are no longer available in the inventory, having been already committed, delivered or picked up. Such can be accomplished by updating a field in a record, setting a flag, or removing the item from the inventory (e.g., on delivery or pick up).

FIG. 16 shows a method 1600 of operating a fulfillment system or portion thereof, according to at least one illustrated implementation. The method 1600 may be employed with the fulfillment system 100 (FIG. 1) or various components or subsystems described herein for example the destination subsystem 112 (FIG. 1) or control subsystem 102 (FIG. 1). In some implementations, the method 1600 can be performed as part of the performing the method 1100 (FIG. 11).

At 1602, at least one processor receives one or more indications of selections of instances of food items for an order. The selections may be received, for example, as get or request commands from a Webpage, or as a user selection via an application executing on a processor-based device operated by a user. For example, the user provide selections that indicate a type of food item (e.g., beef, steak), a type of cut (New York), a weight or approximate weight, an amount or extent of marbling, a desired level of doneness (e.g., rare, medium, well done), and/or a specific manner of cooking (e.g., grilled, seared, broiled).

At 1604, at least one processor causes two or more of instances of selected food items to be automatically prepared as an assembled food item, meal kit, and/or prepared food item. For example, the processor may send commands or cause commands to be sent to control systems of one or more robotic vehicles, one or more robotic appendages (e.g., motor controller), conveyors to cause the robotics and/or conveyors to automatically retrieve instances of food items, and in some cases may automatically assemble the instances of food items into an assembled food item r meal kit and/or the processor may cause instructions to be presented on one or more displays (e.g., display screen; augmented reality displays) that prompt one or more humans to prepare the instances of food items. For instance, one or more machines or humans may assemble dough, tomato sauce, cheese and toppings into an assembled food item (e.g., pizza, calzone), and optional par-bake or bake the assembled food item. The assembled food item may then be packaged.

For instance, one or more machines or humans may assemble a measure amount of a protein, two vegetables and a set of spices into meal kit packaging, accompanied or unaccompanied by preparation instructions.

For example, the processor may send commands or cause commands to be sent to control systems of one or more robotic vehicles, one or more robotic appendages (e.g., motor controller), conveyors, ovens, stoves, broilers, steamers, slow cookers, sous vide cookers, deep fryers, etc., to cause the robotics and/or conveyors to automatically retrieve the instances of food items, transport the instances of food to one or more appliances, and/or control a state, a temperature, and a time of the appliances to prepare the instances of food items per the instructions. The instances of food items may have been previously assembled into an assembled food item.

Various embodiments of the devices and/or processes via the use of block diagrams, schematics, and examples have been set forth herein. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

When logic is implemented as software and stored in memory, one skilled in the art will appreciate that logic or information, can be stored on any computer readable medium for use by or in connection with any computer and/or processor related system or method. In the context of this document, a memory is a computer readable medium that is an electronic, magnetic, optical, or other another physical device or means that contains or stores a computer and/or processor program. Logic and/or the information can be embodied in any computer readable medium for use by or in connection with an instruction execution system, apparatus, or device, such as a computer-based system, processor-containing system, or other system that can fetch the instructions from the instruction execution system, apparatus, or device and execute the instructions associated with logic and/or information. In the context of this specification, a “computer readable medium” can be any means that can store, communicate, propagate, or transport the program associated with logic and/or information for use by or in connection with the instruction execution system, apparatus, and/or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette (magnetic, compact flash card, secure digital, or the like), a random access memory (RAM), a read-only memory (ROM), an erasable programmable read-only memory (EPROM, EEPROM, or Flash memory), an optical fiber, and a portable compact disc read-only memory (CDROM). Note that the computer-readable medium, could even be paper or another suitable medium upon which the program associated with logic and/or information is printed, as the program can be electronically captured, via for instance optical scanning of the paper or other medium, then compiled, interpreted or otherwise processed in a suitable manner if necessary, and then stored in memory.

In addition, those skilled in the art will appreciate that certain mechanisms of taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the above U.S. patents, U.S. patent application publications, U.S. patent applications, foreign patents, foreign patent applications and non-patent publications referred to in this specification and/or listed in the Application Data Sheet, including but not limited to U.S. patent application Ser. No. 13/920,998, filed Jun. 18, 2013; U.S. patent application Ser. No. 62/311,787; U.S. patent application Ser. No. 15/040,866, filed Feb. 10, 2016; PCT Application No. PCT/US2014/042879, filed Jun. 18, 2014; U.S. patent application Ser. No. 15/465,228, filed Mar. 21, 2017; U.S. Provisional Patent Application No. 62/311,787, filed Mar. 22, 2016; PCT Application No. PCT/US2017/023408, filed Mar. 21, 2017; U.S. patent application Ser. No. 15/481,240, filed Apr. 6, 2017; U.S. Provisional Patent Application No. 62/320,282, filed Apr. 8, 2016; PCT Application No. PCT/US2017/026408, filed Apr. 6, 2017; U.S. Provisional Patent Application No. 62/394,063, filed Sep. 13, 2016; U.S. Provisional Patent Application No. 62/532,914, filed Jul. 14, 2017; U.S. patent application Ser. No. 15/701,099, filed Sep. 11, 2017; PCT Application No. PCT/US2017/050950, filed Sep. 11, 2017; U.S. Provisional Patent Application 62/532,885, filed Jul. 14, 2017; U.S. Provisional Patent Application No. 62/531,131, filed Jul. 11, 2017; U.S. Provisional Patent Application No. 62/531,136, filed Jul. 11, 2017; U.S. Provisional Patent Application No. 62/529,933, filed Jul. 7, 2018; U.S. Provisional Patent Application No. 62/620,931, filed Jan. 23, 2018; U.S. Provisional Patent Application No. 62/682,038, filed Jun. 7, 2018; U.S. Provisional Patent Application No. 62/685,067, filed Jun. 14, 2018; U.S. Provisional Patent Application No. 62/613,272, filed Jan. 3, 2018; U.S. patent application Ser. No. 29/558,872; U.S. patent application Ser. No. 29/558,873; and U.S. patent application Ser. No. 29/558,874; and International patent application PCT/US2018/040714, are each incorporated herein by reference, in their entirety.

From the foregoing it will be appreciated that, although specific embodiments have been described herein for purposes of illustration, various modifications may be made without deviating from the spirit and scope of the teachings. Accordingly, the claims are not limited by the disclosed embodiments.

1. A method, comprising:
providing a user interface with a presentation of food items;
receiving a first input that specifies a type of food item through the user interface;
in response to receiving the first input,
identifying, from a data store, a set of instances of food items comprising a plurality of instances of food items of the type of food item specified by the first input, wherein the set of instances of food items are each respective vendable items of food from an inventory of instances of food items;
for each of the instances of food items in the set of instances of food items, retrieving, from the data store, attribute information of the instances of food items, wherein the attribute information includes an image of each respective instance of the food item, and the attribute information is stored by the data store prior to the identifying of the set of instances of the food items;
determining, based in part on a physical characteristic of each respective instance of the food item, a ripeness of each respective instance of the food item;
causing a presentation of a portion of the retrieved attribute information of the instances of food items, the presented portion of the attribute information including the image and the ripeness of each respective instance of the food item;
receiving an indication of a selection of at least one of the instances of the food items; and
causing the at least one of the instances of the food items identified by the selection to be retrieved to fulfill an order.

2. The method of claim 1, wherein causing the presentation of attribute information includes causing the presentation of a weight or a spatial dimension of the respective instances of the food items.

3. The method of claim 1, further comprising:
determining, based in part on a physical characteristic of a meat food item, a marbling of the meat food item; and
causing the presentation of the marbling of the meat food item.

4. The method of claim 1, wherein causing the presentation of the portion of the retrieved attribute information of the instances of food items includes causing the presentation of information that represents a respective firmness, luster, or density of the instances of food items.

5. The method of claim 1, further comprising:
receiving a second input that specifies at least one desired attribute of the type of food item, and wherein identifying a set of instances of food items includes identifying instances of food items having the at least one desired attribute specified by the second input.

6. The method of claim 5, further comprising:
determining whether a total number of instances of food items satisfying a set of search criteria based on the first and second inputs exceeds a threshold, and wherein identifying the set of instances of food items includes selecting a subset of the total number of instances of food items to present via the user interface.

7. The method of claim 1, further comprising:
determining a subset of instances of food items to present via the user interface based on one or more of a current instances of food items available at a single inventory or at least one or more previous selections.

8. The method of claim 1, further comprising:
based on a first number of selected instances of food items, determining a set of inventory locations that have an inventory from which the selected instances of food items can be fulfilled; and
reducing the set of instances of food items for presentation based on the current inventory available at one or more of the set of inventory locations.

9. The method of claim 1, further comprising:
for at least one of the instances of food items, at least temporarily preventing any further identifying of the one instance of food item for a second user in response to a subsequent first input, until a termination criterion is reached.

10. The method of claim 1, further comprising:
automatically assembling two or more of the instances of the food items identified by the selection to an assembled food item or meal kit.

11. A processor-based fulfillment system, comprising:
an inventory subsystem to store food items and attribute information associated with the stored food items;
a production subsystem comprising one or more conveyors, robots, and packaging equipment; and
at least one processor configured to control one or more operations of the inventory subsystem and the production subsystem, wherein the at least one processor is further configured to:
provide a user interface with a presentation of food items;
receive a first input that specifies a type of food item through the user interface;
in response to receiving the first input,
identify, from a data store, a set of instances of food items comprising a plurality of instances of food items of the type of food item specified by the first input, wherein the set of instances of food items are each respective vendable items of food from an inventory of instances of food items;
for each of the instances of food items in the set of instances of food items, retrieve, from the data store, attribute information of the instances of food items, wherein the attribute information includes an image of each respective instance of the food item, and the attribute information is stored by the data store prior to the identifying of the set of instances of the food items;
determine, based in part on a physical characteristic of each respective instance of the food item, a ripeness of each respective instance of the food item;
cause a presentation of a portion of the retrieved attribute information of the instances of food items, the presented portion of the attribute information including the image and the ripeness of each respective instance of the food item;
receive an indication of a selection of at least one of the instances of the food items; and
cause the at least one of the instances of the food items identified by the selection to be retrieved to fulfill an order.

12. The processor-based fulfillment system of claim 11, wherein the at least one processor is further configured to:
cause presentation of information that represents a respective firmness, luster, or density of the instances of food items.

13. The processor-based fulfillment system of claim 11, wherein the at least one processor is further configured to:
receive a second input that specifies at least one desired attribute of the type of food item; and
identify instances of food items having the at least one desired attribute specified by the second input.

14. A method, comprising:
for each of a plurality of instances of the food items of a single type of food item,
capturing via an image sensor an image of the instance of the food item;
sensing via a sensor at least one physical characteristic of the instance of food item that characterizes the instance of the food item;
based on the image and the at least one physical characteristic of the instance of the food item, determining a classification of the instance of food item, and
storing to a data store on one or more processor-readable media in a form retrievable for presentation, the captured image and a value the represents the at least one physical characteristic and the determined classification along with an identifier that identifies the instance of the food item at least until the instance of the food item is delivered to a user.

15. The method of claim 14, wherein sensing the at least one physical characteristic of the instance of the food item includes capturing a weight, a physical spatial dimension, a firmness, a sound in response to the instance of food being tapped, or a smell of the instance of the food item.

16. The method of claim 14, wherein determining a classification includes determining a ripeness of the instance of the food item via at least one processor and storing an indication of the determined level of ripeness of the instance of the food item in the data store associated with the identifier.

17. The method of claim 16, wherein determining the ripeness of the instance of the food item includes assessing one or more colors, luster, firmness, sound, density or scent based at least in part on the image and/or the sensed physical characteristic of the instance of the food item.

18. The method of claim 14, wherein determining the classification includes determining a first classification of the instance of food items from a set of classifications for the type of instance of food item, and the method further comprises:
determining a time when the instance of food item will change from the first classification to a second and different classification.

19. The method of claim 14, further comprising:
determining at least a second physical characteristic based at least in part on the sensed at least one physical characteristic.

20. The method of claim 14, further comprising:
receiving other product data of the instance of food item from a supply chain of the instance of food item, and wherein determining a classification of the instance of food item is based at least in part on at least a portion of the other product data.
